(19) United States
(12) Patent Application Publication
(10) Pub. No.: US 2016/0207789 A1
(43) Pub. Date: Jul. 21, 2016

(54) ELONGATED TITANATE NANOTUBE, ITS SYNTHESIS METHOD, AND ITS USE

(71) Applicant: NANYANG TECHNOLOGICAL UNIVERSITY, Singapore (SG)

(72) Inventors: Yuxin TANG, Singapore (SG); Yanyan ZHANG, Singapore (SG); Zhili DONG, Singapore (SG); Zhong CHEN, Singapore (SG); Xiaodong CHEN, Singapore (SG)

(21) Appl. No.: 15/022,383

(22) PCT Filed: Sep. 16, 2014
(86) PCT No.: PCT/SG2014/000435

§ 371 Date: Mar. 16, 2016

Related U.S. Application Data
(60) Provisional application No. 61/951,194, filed on Mar. 11, 2014.
(60) Provisional application No. 61/878,456, filed on Sep. 16, 2013.

(51) Int. Cl. C01G 23/04; B01J 23/50; B01J 35/00; H01M 4/04; B01J 37/00; B01J 37/34; H01M 4/485; B01J 21/06; B01J 37/04

(52) U.S. Cl. CPC C01G 23/04; B01J 21/063; B01J 23/50; B01J 35/004; B01J 35/0013; B01J 37/04; B01J 37/0072; B01J 37/009; B01J 37/345; H01M 4/485; H01M 4/0402; H01M 4/0471; C01P 2004/13; Y10S 977/896; Y10S 977/932; B82Y 40/00

(57) ABSTRACT

The invention relates to a method of forming high aspect ratio titanate nanotubes. In particular, the formation of elongated nanotubes having lengths more than 10 μm involves a modified hydrothermal method. The method allows formation of an entangled network of the elongated nanotubes for use as free-standing membranes or powder form for use in various applications such as water treatment. The elongated nanotubes may also be used for forming electrodes for batteries.

### CROSS-REFERENCE TO RELATED APPLICATIONS

This application claims the benefits of priority of U.S. Provisional Patent Application No. 61/878,456, filed Sep. 16, 2013, and U.S. Provisional Patent Application No. 61/951,194, filed Mar. 11, 2014, the contents of which being hereby incorporated by reference in their entirety for all purposes.

### TECHNICAL FIELD

The invention relates to a method for forming high aspect ratio titanate nanotubes. In particular, the formation of elongated nanotubes having lengths more than 10 μm involves a modified hydrothermal method. The method allows formation of an entangled network of the elongated nanotubes for use in various forms, such as a powder form, or as free-standing membranes for water treatment by absorption and/or photodegradation. Also, the elongated nanotubes can be used for forming electrodes for batteries, such as lithium ion batteries.

### BACKGROUND

One-dimensional (1D) nanosized materials have been studied for more than two decades ever since the discovery of carbon nanotubes. Although carbon nanotubes seem promising in solving many engineering challenges, their practical applications are still limited due to inadequate selective synthesis strategies. Therefore, various inorganic 1D nanostructures have been developed with simple synthesis routes, such as metal sulfides and metal oxides. Among the metal oxides, 1D titania/titanate nanostructures, such as nanotubes, nanowires, and nanofibers have recently been intensively studied due to their unique layered structures for ion substitution and promising applications ranging from pollutants absorption, Li-ion battery, solar cell, and hydrogen sensoring. Among all the TiO₂-related structures, titanate nanotubes have high surface area and high ion exchange capabilities, which makes it more suitable for cation substitution and absorption of pollutants. Therefore, ever since the discovery of the alkaline hydrothermal synthesis of titanate nanotubular structure, many efforts have been devoted to improving the synthesis method of titanate nanotubes, aiming for facile and low-cost scale-up routes with morphology control.

A typical hydrothermal method involves treatment of commercial anatase powder to a highly alkali environment such as 10M NaOH at 150° C. for more than 20 h, and titanate with nanotubular morphologies were obtained in large quantities and nearly 100% efficiency. Titanate nanotubes have also been synthesized at atmospheric pressure at 100° C. with a mixture of NaOH/KOH solution for 48 h. In addition, intensification of process with ultrasonication assistance or microwave heating has been reported. Such intensification step allows a reduction of synthesis duration from 24 h down to a few hours.

In spite of these efforts, length of the thus-obtained nanotubes is still limited to several hundred nanometers. Development of elongated nanotubes with a relatively high surface area would be of great interest to tailor properties for new era of applications.

### SUMMARY

Mass transport enhancement during the hydrothermal synthesis step was identified to attribute to the length increment for 1D nanostructure. Present inventors have surprisingly found that by stirring the reacting solution with a magnetic stirrer in an enclosed environment during the hydrothermal synthesis step, rotation of the magnetic stirrer in the reacting solution can result in formation of pronounced lengthened nanotubes having lengths of 10 μm or more. Such setup is advantageous because of low energy consumption, ease of scaling up, and a more flexible stirring speed control. Thus, it represents a more viable and efficient approach.

According to a first aspect of the invention, there is provided a method of forming titanate nanotubes each having a length of at least 10 μm.

The method comprises heating a closed vessel containing a titanate precursor powder dispersed in a base. Content in the closed vessel is simultaneously stirred with a magnetic stirrer during the heating.

The titanate nanotubes may be further dispersed in an acid to obtain protonated titanate nanotubes.

The protonated titanate nanotubes may be further dispersed in a solution containing a silver salt to obtain silver-titanate nanotubes.

According to a second aspect of the invention, use of the silver-titanate nanotubes for forming a silver-titanate membrane is provided.

Accordingly, a method for forming a silver-titanate membrane comprises dispersing the silver-titanate nanotubes in deionized water, filtering, and drying the filtered dispersion.

The silver-titanate membrane may be contacted with hydrogen halide solution or gas to form a silver (I) halide decorated titanate membrane, which is then exposed to at least one of ultra-violet light, visible light, and sunlight irradiation.

According to a third aspect of the invention, use of the titanate nanotubes or protonated titante nanotubes for forming an electrode for use in a battery is provided.

Accordingly, a method for forming an electrode for use in a battery comprises spreading a paste or slurry containing the titanate nanotubes or protonated titanate nanotubes on a metal foil and subjecting the metal foil to a vacuum thermal treatment.

### BRIEF DESCRIPTION OF THE DRAWINGS

In the drawings, like reference characters generally refer to the same parts throughout the different views. The drawings are not necessarily drawn to scale, emphasis instead generally being placed upon illustrating the principles of various embodiments. In the following description, various embodiments of the invention are described with reference to the following drawings.

FIG. 1 shows SEM images of the as-synthesized Na-titanate at 130° C. for 24 h in 10M NaOH solution under different rotational speed illustrated in Example 1: a) 0 rpm, b) 200 rpm, c) 500 rpm, d) 1000 rpm. Scale bar is 1 μm.

FIG. 2 shows TEM images of the as-synthesized Na-titanate at 500 rpm illustrated in Example 1.

FIG. 3 shows XRD pattern of the product inside Teflon liner after cooling for around 1 h illustrated in Example 1.

FIG. 4 shows SEM images of the as-synthesized Na-titanate at 130° C. in 10M NaOH solution under rotation speed of 500 rpm illustrated in Example 1 with durations of: a) 2 h, b) 4 h, c) 8 h, d) 16 h, e) 24 h, f) 48 h. Scale bar is 1 μm.

FIG. 5 shows evolution of XRD profile with reaction time illustrated in Example 1 (A stands for anatase; R stands for rutile; T stands for titanate). Inset shows the photograph of product inside Teflon liner after cooling for around 1 h.

FIG. 6 shows time dependence of specific surface area and total pore volume of the products synthesized at different duration illustrated in Example 1.

FIG. 7 shows SEM images of the as-synthesized Na-titanate obtained in 10M NaOH solution, under 500 rpm for 24 h at reaction temperature of a) 60° C., b) 100° C., c-d) 130° C., e) 150° C., f) 170° C. at 500 rpm rotation speed illustrated in Example 1. Scale bar is 1 μm.

FIG. 8 shows photocatalytic degradation of MB (5 mg/L) in presence of TiO₂ membrane under UV-visible lamp light illustrated in Example 1.

FIG. 9 shows digital images of the fabricated membrane illustrated in Example 1: a) Ag/Titanate membrane, b) AgCl/Titanate membrane, c) Ag/AgCl/Titanate membrane.

FIG. 10 shows cyclic runs for photocatalytic degradation of MB (5 mg/L) in presence of Ag/AgCl/Titanate membrane under visible light illustrated in Example 1. The running time is 3.5 h for each cycle with the first 0.5 h under dark condition.

FIG. 11 shows (a) the multifunctional membrane setup for removal of toxic metal ions; (b) the adsorption membrane (left) before and (right) after adsorption of Fe³⁺ ions illustrated in Example 1.

FIG. 12 shows a schematic illustration of nanostructured materials for lithium-ion batteries illustrated in Example 2. (a) Different dimensional electrode materials for lithium-ion batteries application; and (b, c) Schematics of different aspect ratio (δ) of one-dimensional nanostructure and its corresponding nanotubular-network for additive-free electrode system respectively.

FIG. 13 shows fabrication and characterization of titanate nanotubular structures with different aspect ratio illustrated in Example 2. (a) Digital photos of resulted titanate solution obtained by hydrothermal method with a stirring rate of 500 rpm (left) and 0 rpm (right) after sedimentation; (b) Low magnification FESEM images of titanate nanotubular samples obtained at a stirring rate of 500 rpm; (c) High-magnification TEM image of (b), the arrow indicating the formation of nanotubular structure; (d) XRD pattern of the products synthesized at different stirring speeds; and (e, f, g, h, i) FESEM images of the titanate nanotube samples obtained by hydrothermal reaction between TiO₂ and NaOH at 130° C. for 24 h in 10 M NaOH solution at different rotational speeds of 0, 300, 400, 500 and 1000 rpm respectively.

FIG. 14 shows a correlation of stirring rate on tube parameters, solution viscosity, surface area and aspect ratio of nanotubular structures illustrated in Example 2. The effects of stirring rate on (a) length-diameter of nanotube structure and (b) viscosity of the resultant solution of nanotube structure before thermal treatment; (c) The relationship between the aspect ratio of nanotube structure and their corresponding solution viscosity; (d, e) The relationship between the aspect ratio and surface area and average tube thickness before (black) and after (red) thermal treatment. The red dotted line in (d, e) represents the mean value of surface area and tube thickness, respectively, and the error bar shows the standard deviation. The inset in FIG. 14e is the schematic illustration of the nanotube cross-section (h: tube thickness, r: inner tube diameter).

FIG. 15 shows electrochemical performance of NT-500 titania electrodes illustrated in Example 2. (a) Capacity retention through 100 cycles at C/5 rate showing the charge (red circles) and discharge (black circles); (b) Galvanostatic discharge/charge voltage profiles at a current density of C/5; (c) The cycle performance at various current rates showing charge (red squares) and discharge (black squares); (d) Discharge curves of additive-free NT-500 electrodes at different current rates from C/5 to 30 C. Coulombic efficiency is plotted on the right axis of a and c (blue circles).

FIG. 16 shows electrochemical performance of the nanotubular titania electrodes with different aspect ratio illustrated in Example 2. (a) Statistics on discharge capacities obtained with various current rates from all samples; (b) Correlation between aspect ratio with the capacity of different nanotubular structures at various discharging rates; (c) Scheme of the electron and lithium ion transport pathways; (d) Nyquist plots of the as-prepared electrodes. The Z′ and Z″ represent the real and virtual parts of the complex-valued impedance, respectively; (e) Correlation between aspect ratio with internal resistance and charge-transfer resistance of the as-prepared electrodes; and (f) long-term cycling performance of NT-500 electrodes at a high current density of 30 C, showing the reversible capacity value of 114 mAh g⁻¹ after 6000 cycles with Coulombic efficiency around 100%. Coulombic efficiency of is plotted on the right axis of f (blue circles).

FIG. 17 shows a comparison of the electrochemical performance of representative anatase TiO₂ electrode materials at high rates illustrated in Example 2 (Table 1).

FIG. 18 shows a schematic illustration of experimental setup for the stirring hydrothermal reaction illustrated in Example 2; (a, b and c) Formation of the titanate nanotube structures under different mechanical disturbance conducted at different stirring rates.

FIG. 19 shows FESEM and TEM images of the as-prepared samples illustrated in Example 2: (a-b, c-d, e-f, g-h) Low magnification FESEM images and the corresponding TEM images of titanate nanotube structures obtained at 0, 300, 400, and 1000 rpm respectively.

FIG. 20 shows XRD patterns of the annealed titanate nanotube samples at 500° C. for 2 h in vacuum illustrated in Example 2. The heat treated samples stirred at 0, 300 and 400 rpm possess the anatase phase while the annealed samples prepared stirred at 500 and 1000 rpm possess the mixed anatase and TiO₂(B) phase. A stands for the anatase phase, B stands for the TiO₂(B) phase.

FIG. 21 shows TEM images of the as-prepared different aspect ratio titania nanotubular samples after thermal annealing illustrated in Example 2. The (a-b), (c-d), and (e-f) are the low-high magnification TEM images of nanotubular structures prepared under hydrothermal condition with the stirring rate of 0 rpm, 300 rpm, 500 rpm respectively. The insets in (a), (c), and (e) are their corresponding TEM images taken at lower magnification. The HRTEM images (b, d, f) confirm the formation of anatase phase after thermal treatments.

FIG. 22 shows BET analysis of hydrogen titanate nanotube structures illustrated in Example 2: (a) Nitrogen sorption isotherms and (b) pore-size distributions of titanate nanotube structures formed at different stirring rate. The inset photo in (a) is enlarged from the rectangular area in (a).

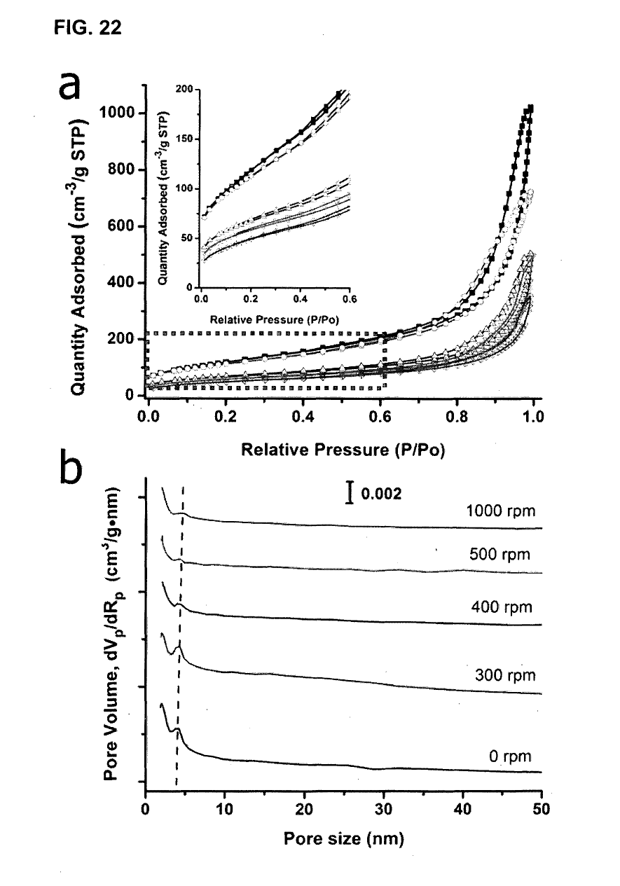

FIG. 23 shows BET TiO₂ nanotube structures illustrated in Example 2: The effects of stirring rate on the tube parameters (surface area and pore size/volume) of (a) titanate nanotube and (b) TiO₂ nanotube. TiO₂ nanotube is obtained from the thermal treatment of hydrogen titanate nanotubular structures at 500° C. for 2 h in vacuum.

FIG. 24 shows cyclic voltammogram of NT-500 electrode in 1 M LiPF₆ and ethylene carbonate/diethyl carbonate (50/50, w/w) at a scan rate of 0.10 mV s⁻¹ illustrated in Example 2. There are three pairs of peaks in the CV curve, which is consistent with previous report. One feature evidence in the plot is a pair of redox peaks between 1.70 V and 2.03 V (marked as A peak), corresponding to the characteristic lithium intercalation behavior observed in anatase and could prove the presence of anatase in the materials, which is consistent with the XRD data (FIG. 20). The other two pairs of peaks located at 1.47 V/1.55 V and 1.57 V/1.67 V (denoted as S1 and S2 peaks) are the typical behavior of lithium storage in TiO₂(B). Such two peaks indicate the presence of two-phase intercalation processes that Li-ion inserts into two sets of sites (S1 and S2) of the TiO₂(B) crystal structure.

FIG. 25 shows cycling responses of the NT-500 electrode at higher current densities illustrated in Example 2. The cycling performance of the NT-500 electrode tested at a high current density of 5, 20 and 30 C for 100 cycles.

FIG. 26 shows models of Li-ion transport along grain boundaries illustrated in Example 2. Schematic illustration of the crystal structure of anatase TiO₂ and possible Li-ion diffusion path in anatase. Anatase consists of TiO₆ octahedral with corner- and edge-sharing configurations. TiO₂ is a lowly anisotropic anode material for Li-ion deintercalation/intercalation since it possesses various Li-ion diffusion pathway into the empty zigzag channels through the [100], [010], [001], [111] and other directions although their diffusion energy barrier for surface transmission of Li-ion differs.

FIG. 27 shows the relationship of the stirring rate with viscosity of the solution, length and diameter of the titanate nanotube illustrated in Example 2 (Table S1).

FIG. 28 shows a schematic illustration of the formation process of short and elongated nanotubular structures under normal and stirring hydrothermal processes at 130° C. for 24 h respectively illustrated in Example 3. (a) TiO₂ nanoparticles was first dispersed in 10 M NaOH aqueous solution in hydrothermal reactor. (b-c) Route I for the formation process of short titanate nanotube by hydrothermal reaction under static condition. (e-f) Route II for the synthetic approach of elongated nanotubular structure under stirring condition. (d) The growth model of nanotube along axial and radial direction (top) and the force analysis (down) of an individual nanotube formed in (e). U is solution velocity, fs is the side force, and r is the diameter of the tube.

FIG. 29 shows (a-d) Typical FESEM images of the nanotubular structures formed at stirring rates of 0, 200, 300, and 500 rpm respectively illustrated in Example 3. (e-f) Low- and high-magnification TEM images of 0 rpm sample. (g-h) Low- and high-magnification TEM images of 500 rpm sample. (i) The relationship between the stirring rate with the nanotubular length, centripetal force, and shear stress of nanotubes. (j) The kinetic study (the nanotubular length, diameter) of the nanotubular sample obtained under 500 rpm. The red curve and navy blue curve are fitting data L using the mixed diffusion- and surface reaction-limited model (DLSLOR model) and diffusion-limited Ostwald ripening (DLOR) control growth model respectively.

FIG. 30 shows (a) proposed formation mechanism of the bending nanotubes with elongated structure illustrated in Example 3. (b-g) TEM characterization of the bending elongated nanotubular structure: (b, c) low- and high-magnification TEM images of the as-synthesized titanate nanotubes obtained at 500 rpm respectively; (d, e, f, g) SAED patterns of the nanotube are taken from (A, B, C, D) marked in (b) respectively.

FIG. 31 shows electrochemical performance of elongated TiO₂(B) nanotubular electrodes illustrated in Example 3. (a) Capacity retention through 100 cycles at C/4 rate showing the charge (red circles) and discharge (black circles). (b) Cycle performance of short and elongated TiO₂(B) nanotubular samples at various current rates. (c) Discharge curves at different current rates of C/10 to 25 C; (d) Cyclic voltammograms at a scan rate of 0.2 mV/s. (e) Cyclic voltammograms at different scan rates from 0.1 to 1.0 mV/s. Inset is the plot of peak reduction current with respect to scan rates. (f) Long-term cycling performance of another cell at a high current density of 25 C, showing the reversible capacity value of 114 mAh g⁻¹ after 10000 cycles with Coulombic efficiency of ca. 100%. The Coulombic efficiency is plotted on the right axis of f (blue circles).

FIG. 32 shows low- and high-magnification of FESEM and TEM images of the samples prepared at different stirring rates illustrated in Example 3. (a, b), (c, d), (e, f) and (g, h) of the samples prepared at different stirring rates of 500, 300, 200, and 0 rpm respectively. High magnification TEM images: (i) and (j) of as-prepared nanotubular samples obtained at 0 and 300 rpm respectively.

FIG. 33 shows X-ray diffraction (XRD) patterns and nitrogen adsorption isotherms of the as-prepared samples illustrated in Example 3. The inset in (b) is their corresponding pore size distribution. Brunauer-Emmett-Teller (BET) results analysis: The as-prepared sodium titanate nanotube samples show typical type IV adsorption isotherm, indicating the presence of mesoporous structure. As the stirring rate increases, the hysteresis loops shift toward higher relative pressure and the area of the hysteresis loops gradually decreases, indicating the decrease of BET surface area and pore volume. The inset in FIG. 33b exhibits that the pore diameter is centered at around 4 nm for all the samples, corresponding to the inner diameter of hollow nanotube, whereas the decreasing peak intensity in the lower range (2-8 nm) is due to self-assembly of the nanotubes and broadening of the tube thickness.

FIG. 34 shows SEM images of the as-synthesized titanate nanostructure with different durations illustrated in Example 3. (a-b) 1 h, (c-d) 2 h, (e-f) 4 h, (g-h) 16 h at 130° C. in 10 M NaOH solution under a stirring speed of 500 rpm.

FIG. 35 shows evolution of XRD profile of the titanate sample obtained at different reaction time illustrated in Example 3. (a) 1 h, (b) 2 h, (c) 4 h, (d) 8 h, (e) 16 h, (f) 24 h with a stirring rate of 500 rpm. A stands for anatase; R stands for rutile; T stands for titanate.

FIG. 36 shows FESEM images of as-prepared three-dimensional TiO₂(B) nanotubular electrode after thermal treatment at 400° C. for 2 h in vacuum and the three-dimensional TiO₂(B) nanotubular electrode after 10000 cycles charging and discharging process at 25 C illustrated in Example 3. (a-b) as-prepared three-dimensional TiO₂(B) nanotubular electrode after thermal treatment at 400° C. for 2 h in vacuum and (c-d) the three-dimensional TiO₂(B) nanotubular electrode after 10000 cycles charging and discharging process at 25 C. The micro-particles appear on the TiO₂(B) nanotubular electrode in (d) are the LiPF₆ precipitate from the electrolyte. The insets in (b) and (d) is the high-magnification images of (a) and (c) respectively.

FIG. 37 shows XRD pattern and isotherm nitrogen sorption of the elongated TiO₂(B) nanotube, which was annealed from the hydrogen titanate nanotubular sample at 400° C. for 2 h in vacuum illustrated in Example 3. The characteristic peaks in (a) comes from TiO₂(B) (JCPDS card no. 46-1237) crystal structure. Inset in (b) shows its pore volume distribution (BJH desorption). The surface area of elongated TiO₂(B) nanostructure was about 130.2 m²/g with mesoporous structure, and the pore size distribution below 5 nm mainly comes from the inner hollow space of nanotubular structure.

FIG. 38 shows TEM images of the elongated TiO₂(B) nanotubular structure observed after the thermal treatment of the long hydrogen titanate nanotubular structure obtained at 500 rpm illustrated in Example 3. (a) low-magnification; (b, c) high-magnification of multi-wall nanotube, which are taken from two positions (square area) of a nanotube in inset of (b); (d) high-resolution TEM images, and the inset in (d) is the corresponding diffraction pattern.

FIG. 39 shows TEM images of the short TiO₂(B) nanotubular structure observed after the thermal treatment of the short hydrogen titanate nanotubular structure obtained at 0 rpm illustrated in Example 3. (a, b, c) low-magnification; (d) high-magnification of short nanotube.

FIG. 40 shows Nyquist plots of the TiO₂(B) nanotubular electrodes after thermal annealing illustrated in Example 3. Z′ and Z″ represent the real and virtual parts respectively of the complex-valued impedance.

### DESCRIPTION

The following detailed description refers to the accompanying drawings that show, by way of illustration, specific details and embodiments in which the invention may be practised. These embodiments are described in sufficient detail to enable those skilled in the art to practise the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Herein, it is disclosed a method of synthesizing high aspect ratio titanate nanotubes with length scale of 10 μm or more, and its uses as free-standing multifunctional membranes and electrodes for batteries.

In present context, a nanotube is said to be elongated when its length scale is 10 μm or more. For a plurality of nanotubes, generally the nanotubes are said to be elongated when the average length scale is 10 μm or more.

In present context, aspect ratio is defined by the ratio L/D where L denotes a length along the longitudinal direction and D denotes a diameter of a titanate nanotube. Typically, the diameter of a titanate nanotube is 0.1 μm or less, so that the aspect ratio in present context is at least 100.

Accordingly, a method of forming titanate nanotubes each having a length of at least 10 μm is provided.

The method comprises heating a closed vessel containing a titanate precursor powder dispersed in a base. Content in the closed vessel is simultaneously stirred with a magnetic stirrer during the heating.

The advantage of stirring the content in the closed vessel (i.e. the reaction mixture) is that the rotation of the magnetic stirrer inside the closed vessel creates spiral pattern of mass flow, which facilitates attachment of reactants onto the end of small nanotubes to form entangled nanotubular structures. For example, as further described in Example 3 below, an obvious increase in diameter and length of the resulting 1D titanate nanostructure can be observed when the stirring rate is increased. While a static growth (i.e. without stirring) leads to formation of relatively straight nanostructure, the 1D nanostructure of present disclosure is bent under mechanical stirring, and the degree of bending increases with the increase of stirring rate.

The closed vessel can be an autoclave. Alternatively, the closed vessel may be provided by an enclosed chamber or system whereby the content therein can be subjected to hydrothermal conditions.

As used herein, the term “titanate precursor” refers to a precursor of titanate, and includes any suitable compounds that may be used to form titanate nanotubes. The term “titanate” refers to inorganic compounds containing oxides of titanium such as orthotitanates and/or metatitanates. For example, the titanate nanotube may be a sodium titanate nanotube or a hydrogen titanate nanotube.

) In various embodiments, the titanate precursor may comprise or consist of titania. In some embodiments, the titanate precursor powder may comprise anatase titanium oxides, rutile titanium oxides, brookite titanium oxides (TiO₂), combinations thereof, or any mixed phase of them. Additionally or alternatively, the titanate precursor powder may include, but is not limited to, amorphous titanium oxyhydroxide, amorphous titanium hydroxide, or minerals known as rutile or ilmenite.

In one embodiment, the titanate precursor powder comprises mixed phases of anatase TiO₂ and rutile TiO₂. Such mixed phases of anatase and rutile TiO₂ are available commercially, such as P25 powder from Degussa.

In various embodiments, the base in which the titanate precursor powder is dispersed may comprise sodium hydroxide (NaOH), potassium hydroxide (KOH), ammonium hydroxide (NH₄OH). Alternatively, the base may be provided by any other hydroxide.

In certain embodiments, the base comprises 5M NaOH, 6M NaOH, 7M NaOH, 8M NaOH, 9M NaOH, or 10M NaOH.

In one embodiment, the base comprises 10 M NaOH.

Concentration of titanate precursor powder in the base in the closed vessel may be controlled to form titanate nanotubes having an average length of at least 10 μm. Concentration of the titanate precursor powder in the base may be about 1:300 g/ml or more. In various embodiments, concentration of the titanate precursor powder in the base is in the range of about 1:150 g/ml to about 1:50 g/ml.

In various embodiments, the content in the closed vessel is stirred at 400 rpm or more, such as 500 rpm, or more.

Preferably, the content in the closed vessel is stirred at 400 rpm to 1,000 rpm.

Present inventors have found that the stirring speed of the magnetic stirrer plays a role in defining the morphology of the resultant titanate nanotubes. For a stirring speed of less than 400 rpm, such as 200 rpm, lengthening of the structure is observed but with no obvious entangled pattern. With further increase of rotation speed to 400 rpm, entangled nanostructure with length scale exceeding ten micrometer was obtained, which is orders of magnitude higher than the reported value in literature. Under more agitated conditions (1000 rpm or more), no significant morphological change is induced. However, the nanotubes were observed to agglomerate and lie parallel to each other with each other to form bundled structures.

Present inventors have also found that by heating the closed vessel at 60° C., most of the products remained as particles rather than nanotubes. When temperature was increased to 80° C., long entangled nanotubes was found to dominate the morphology of the product. When temperature is higher than 130° C., the obtained products become straight and solid (non-porous), indicating formation of titanate nanowires.

Accordingly, in various embodiments, the closed vessel is heated at 130° C. or below.

Preferably, the closed vessel is heated at between 80° C. and 130° C.

The closed vessel may be heated in an oil bath, such as a silicon oil bath, or an apparatus adapted to provide a constant heating temperature, such as an oven or furnace. For a more uniform heating, the closed vessel may be heated in an oil bath. For example, the oil bath may be a silicon oil bath.

The closed vessel may be completely or partially immersed in the oil bath for heating.

Present inventors have found that transformation from anatase TiO₂ (as an example of a titanate precursor) to titanate starts from as early as 2 h, with titanate nanotubes bridged and grafted among particles. Such a fast reaction can be attributed to intense mixing within the closed vessel, which improves the contact area of reactants. When reaction was carried out for 4 h, titanate nanotubular structure starts to dominate the morphology of products. After 16 h of reaction, the obtained products show clearly long and entangled nanotubular structure, which become comparable to that of 24 h. However, it was observed that further increment of reaction time causes straightening of the nanotubes; in addition, the nanotubes start to be aligned in a parallel fashion into bundle-like secondary structures.

Thus, in various embodiments, the closed vessel is heated for 24 h or less.

Preferably, the closed vessel is heated for 16 h to 24 h.

In various embodiments, the method may further comprise collecting the thus-formed titanate nanotubes via centrifugation or filtration. In some embodiments, the thus-formed titanate nanotubes are collected via centrifugation.

Post-treatment of the thus-formed titanate nanotubes may include washing the collected titanate nanotubes with deionized water to reduce pH to 9 or below. This may be followed by drying the washed titanate nanotubes. For example, the drying may be carried out at 80° C. for 12 h. Drying the washed titanate nanotubes may include forming the dried titanate nanotubes as a powder and/or a free-standing membrane.

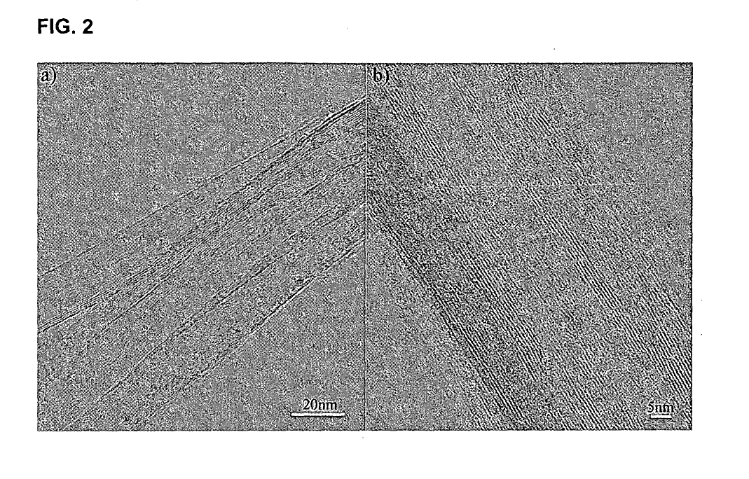

Each of the thus-formed titanate nanotubes has a length of at least 10 μm. In various embodiments, the titanate nanotubes formed using a method disclosed herein are hollow, such as that shown in FIG. 2. The titanate nanotubes may be opened at both ends.

As mentioned above, transformation from TiO₂ (as an example of a titanate precursor) to titanate starts from as early as 2 h, with titanate nanotubes bridged and grafted among particles. When reaction was carried out for 4 h, titanate nanotubular structure starts to dominate the morphology of products, and after 16 h of reaction, the obtained products show clearly long and entangled nanotubular structure. Some TiO₂ may nevertheless remain in the titante nanotubes. In various embodiments, the titanate nanotubes comprise TiO₂. Advantageously, free-standing, porous membranes containing titanate nanotubes only or titanate nanotubes containing a combination of titanate and TiO₂, may be obtained. The free-standing, porous membranes may, for example, be obtained by collecting the titanate nanotubes via centrifugation or filtration to form a titanate nanotubes membrane.

In embodiments where the membranes are formed of titanate nanotubes comprising TiO₂, the titanate and TiO₂ may be used in applications such as wastewater treatment, to simultaneously remove pollutants of organic dyes, and toxic metal ions, such as Pb, Cr, and/or Cd. For example, portions of the membrane containing TiO₂ may be used as a photocatalyst to decompose organic pollutants under light irradiation, while portions of the membrane containing titanate may act as a strong adsorbent to remove trace amount of toxic metal ions.

Alternatively, or in addition to the above, titanate nanotubes-TiO₂ membranes which are able to demonstrate the above-mentioned functionalities may be formed by arranging a titantate nanotubes membrane on a TiO₂ membrane. The TiO₂ membrane may be a porous membrane comprising of consisting of TiO₂.

In various embodiments, arranging the titanate nanotubes membrane on a TiO₂ membrane includes heating a titanate nanotubes membrane at a temperature of at least 300° C. to obtain a TiO₂ nanotubes membrane, and collecting titanate nanotubes via filtration on the TiO₂ nanotubes membrane to obtain the titanate nanotubes-TiO₂ membrane. By heating the titanate nanotubes membrane at a temperature of 300° C. or more, the titanate nanotubes may be converted to titania nanotubes. By collecting titanate nanotubes on the TiO₂ nanotubes membrane, titanate nanotubes-TiO₂ membranes may be formed. In the embodiment described, the TiO₂ membrane is a TiO₂ nanotubes membrane. This process may be repeated one or more times to form a multilayer titantate nanotubes-TiO₂ membrane.

As mentioned, arranging the titanate nanotubes membrane on a TiO₂ membrane may be repeated one or more times to form a multilayer titantate nanotubes-TiO₂ membrane. The multilayer titantate nanotubes-TiO₂ membrane may include one or more titantate nanotubes membrane and one or more TiO₂ membrane arranged in an alternating sequence or in a a random sequence.

In order to obtain protonated titanate nanotubes (i.e. hydrogen-titanate nanotubes) for further use or application, the dried titanate nanotubes may be dispersed in an acid. The acid may comprise nitric acid, hydrochloric acid, or sulfuric acid. Other acids or acidic solutions may also be used.

Post-treatment of the thus-obtained protonated titanate nanotubes may include collecting the protonated titanate nanotubes via centrifugation and/or filtration, washing and drying the same.

The dried protonated titanate nanotubes may be dispersed in a solution containing a silver salt to obtain silver-titanate nanotubes. For example, the silver salt may comprise silver (I) nitrate solution.

According to a second aspect of the invention, use of the silver-titanate nanotubes for forming a silver-titanate membrane is provided.

The method for forming the silver-titanate membrane comprises dispersing the silver-titanate nanotubes in deionized water, followed by filtering and drying the filtered dispersion.

The thus-obtained silver-titanate membrane may be contacted with hydrogen halide (HX, X═Cl, Br I) solution or gas to form a silver (I) halide (AgCl, AgBr, AgI) decorated titanate membrane, and which may then be exposed to at least one of ultraviolet (UV) light, visible light, and sunlight irradiation. In embodiments wherein the hydrogen halide comprises or consists of concentrated hydrochloric acid, for example, a silver (I) chloride decorated titanate membrane may be obtained, which may then be exposed to ultra-violet light, visible light, and/or sunlight light irradiation for post-treatment.

Discussion on the potential use of the silver-titanate membrane and silver (I) chloride decorated titanate membrane can be found in Example 1 below.

According to a third aspect of the invention, use of the titanate nanotubes or protonated titante nanotubes for forming an electrode for use in a battery is provided.

Accordingly, a method for forming an electrode for use in a battery comprises spreading a paste or slurry containing the titanate nanotubes or protonated titanate nanotubes on a metal foil and subjecting the metal foil to a vacuum thermal treatment.

For example, the metal coil can comprise of any metal suitable for use as an electrode. Conveniently, the metal coil may comprise, but is not limited to, copper.

In various embodiments, the metal foil may be subjected to vacuum thermal treatment at a temperature in the range of about 200° C. to about 500° C. for a time period in the range of about 1 hour to about 5 hours. In specific embodiments, the metal foil may be subjected to vacuum thermal treatment at 500° C. for 2 h.

Discussion on the potential use of the titanate nanotubes or protonated titante nanotubes can be found in Examples 2 and 3 below.

By “comprising” it is meant including, but not limited to, whatever follows the word “comprising”. Thus, use of the term “comprising” indicates that the listed elements are required or mandatory, but that other elements are optional and may or may not be present.

By “consisting of” is meant including, and limited to, whatever follows the phrase “consisting of”. Thus, the phrase “consisting of” indicates that the listed elements are required or mandatory, and that no other elements may be present.

The inventions illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

By “about” in relation to a given numerical value, such as for temperature and period of time, it is meant to include numerical values within 10% of the specified value.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples. In addition, where features or aspects of the invention are described in terms of Markush groups, those skilled in the art will recognize that the invention is also thereby described in terms of any individual member or subgroup of members of the Markush group.

In order that the invention may be readily understood and put into practical effect, particular embodiments will now be described by way of the following non-limiting examples.

### EXAMPLES

### Example 1

### Synthesis of Elongated High Aspect Ratio Titanate Nanotubes and Applications as Free-Standing Multifunctional Membranes

In this example, elongated high aspect ratio titanate nanotubes were successfully synthesized by a modified hydrothermal method in oil bath with agitation. The morphology, crystal structure, and surface area were characterized by scanning electron microscopy, transmission electron microscopy, X-ray diffraction and nitrogen adsorption/desorption isotherm analysis. The experimental results revealed that under intense agitation with rotation speed exceeding 500 rpm, an intimate mixture of liquid solution and solid products can be obtained. Titanate nanotubes with average length longer than 10 μm can be successfully synthesized. Further increase of rotation speed has negligible effect on the morphology, but it promotes alignment of nanotube into bundle-like secondary structures. The effect of reaction time and reaction temperature on the morphology of the titanate structure has been studied. At prolonged synthesis time, the titanate nanotubes agglomerate into nanowire-like structures. At higher synthesis temperature greater than 150° C., only nanowire structure was obtained. It is proposed that rotation of magnetic stirrer inside the autoclave creates spiral pattern of mass flow, which facilitates the attachment of the reactants into the end of small nanotubes to form entangled nanotubular structures. The unique structure enables the formation of porous free-standing ceramic membranes. The fabricated free-standing membranes composed of anatase TiO₂ and titanate multilayer exhibited multifunctional properties. They show excellent photocatalytic performance by the TiO₂ layer under ultraviolet light for degradation of organic compound and strong adsorption performance by the titanate layer for removing toxic metal ions. Also, by loading Ag/AgCl nanoparticles on the multi-functional membranes, the membrane exhibited excellent degradation performance under visible light due to localized surface plasmon resonance effect of Ag/AgCl nanoparticles.

Synthesis

A commercially available P25 powder (Degussa, Purity 99.8%) was used as the TiO₂ precursor. In a typical synthesis, 0.1 g of P25 powder was dispersed into 15 ml of NaOH solution with continuous stirring for around 10 min, and then transferred into 25 ml Teflon-lined stainless-steel autoclave. The autoclave was heated and stirred inside a silicon oil bath for different time. The stirring speed and reaction temperature can be easily adjusted via the control panel attached to the hot plate. After reaction, the autoclave was taken out from oil bath and cooled to room temperature. The product was collected by centrifugation, washed with deionized water several times to reach a pH value of 9 and followed by drying at 80° C. for 12 h.

Ion substitution of Na⁺ by H⁺ was done with HNO₃ solutions. The dried sodium titanate powder was dispersed in a diluted HNO₃ solution (0.1M) and agitated for 2-5 mins and then centrifuged at 7000 rpm for 8 mins. The agitation time is less than 5 min to avoid breakage of long nanotubes under acidic condition. This process is repeated three times. The suspension was then centrifuged, washed with deionized water several times, and then dried at 80° C. for about 12 hours to collect the H-titanate as a product.

Subsequently, the substitution of H⁺ by Ag⁺ was achieved with 0.1M AgNO₃ solution. In a typical process, 100 mg H-titanate powder was dispersed into 100 ml AgNO₃ solution for 3 h. The stirring speed is kept to be lower than 200 rpm to avoid breakage of long titanate nanotubes into small fragments.

Fabrication of Ag-titanate membrane was done via a simple filtration method. In a typical procedure, 20 mg of Ag-titanate powder was dissolved in 20 mL of deionized (DI) water to obtain a homogeneous mixture. The mixture was then dropped onto a filtrating membrane (diameter 20 mm) on top of 70 mm diameter filter paper. The filter flask was connected to a vacuum pump and the filtration pressure was maintained at around −600 mbar. After filtration, the obtained membrane was dried at 70° C. in oven for 16 h.

In situ formation of AgCl is done by introduction of hydrochloric acid. In a typical process, the membrane was put into glass petri dish containing one droplet of concentrated hydrochloric acid (37%) for 5 min. then it was dried in an oven at 70° C. for about 6 h. To form the desired Ag/AgCl, the AgCl decorated membrane was exposed to ultra-violet light irradiation with intensity around 100 mW/cm² for 1.5 h.

Characterization

The morphologies of the as-synthesized samples were examined by field emission scanning electron microscopy (FESEM, JEOL JSM-6340F). Transmission electron microscopy (TEM, JEOL JEM-2010) operating at 200 kV was used to further confirm the detailed nanostructures. The powder X-Ray diffraction (XRD) patterns were obtained by Bruker 6000 X-ray diffractometer using a Cu Kα source. Nitrogen adsorption/desorption isotherms were measured at 77K using ASAP 2000 adsorption apparatus from Micromeritics. The samples were degassed at 373 K for 6 h under vacuum before analysis.

Performance Measurement

To investigate the photocatalytic activities, methylene blue (MB) was used as the target organic molecule to be degraded. A supercold filter (YSC0750) is used to provide visible light in the 400 nm to 700 nm regime with the light intensity adjusted to 100 mW/cm² during each cycle; the membrane was immersed in the MB solution under dark for 30 min prior to light irradiation to achieve adsorption/desorption isotherm. The MB concentration at different reaction time points was obtained using Perkin-Elmer UV-Vis-NIR Lambda 900 spectrophotometer.

Results And Discussion

Effect of Rotation Speed

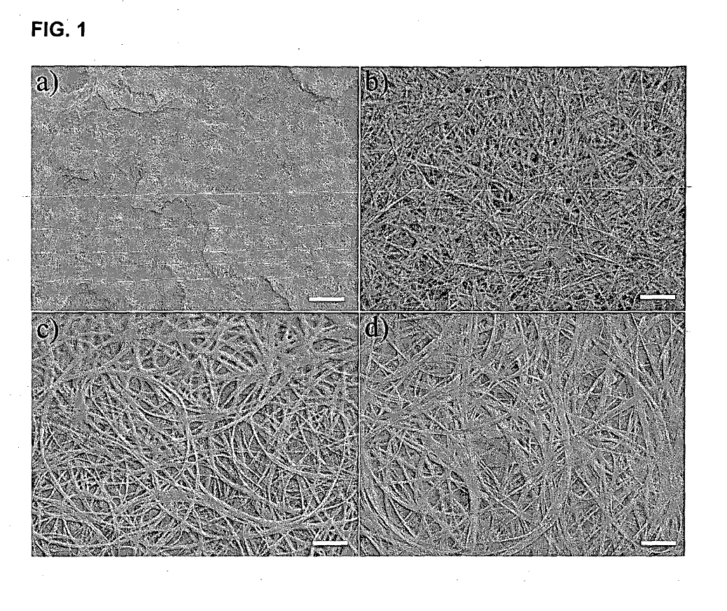

The morphologies of final products after reaction at 130° C. for 24 h in 10M NaOH solution under various rotation speeds were observed via scanning electron microscope and shown in FIG. 1. Under static condition, the products are randomly oriented nanotubes; but the tubular structure is rarely observable due to shorter length scale of only several hundred nanometers. When the rotation speed increases to 200 rpm, lengthening of the structure is observed but with no obvious entangled pattern. With further increase of rotation speed to 500 rpm, entangled nanostructure with length scale exceeding ten micrometer was obtained, which is orders of magnitude higher than the reported value in literature. Since the end of the nanotubes was rarely observable in such structures even at low magnifications, the exact length may be even longer than 10 μm. Under more agitated conditions (1000 rpm), no significant morphological change is induced. However, the nanotubes were observed to agglomerate and lie parallel to each other with each other to form bundled structures.

To further confirm the morphology of the synthesized product, TEM images were obtained for the product synthesized at 500 rpm rotation speed. The multi-wall nanotubular structure with hollow interior can be identified clearly in the FIG. 2a (the hollow interior is lighter in color). The wall of nanotube consists of several layers, separated by the interlayer distance of 0.74 nm (measured from FIG. 2b), which falls well in the range of 0.7-0.8 nm for titanate nanotubes.

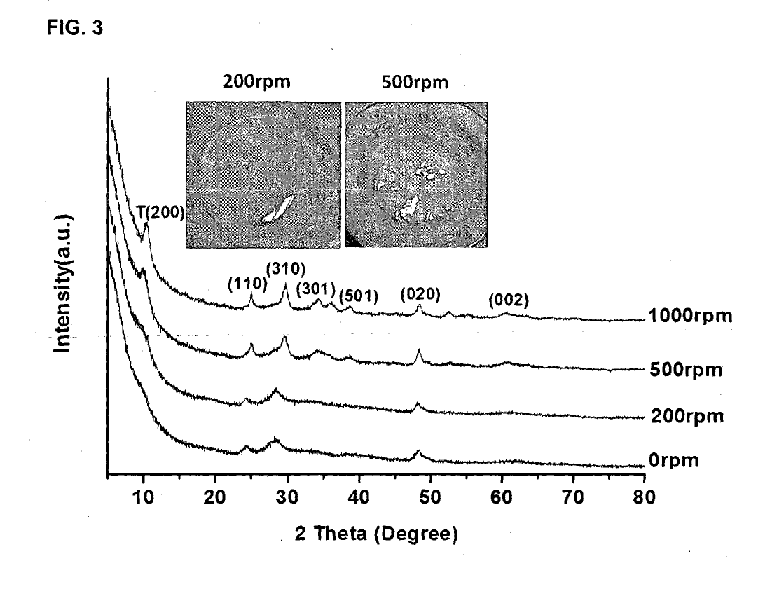

The X-ray diffraction (XRD) patterns of the nanotubes synthesized under different rotation speed are shown in FIG. 3. No apparent difference can be identified with that of titanate materials synthesized under static condition. Typically for titanate nanotubes, there is characteristic 2θ value at around 10° corresponding to the (200) plane. Reflections at 10°, 24.6°, 28.8°, 34.9°, 38.8°, 48.6° and 62° (2θ), corresponding to the (200), (110), (310), (301), (501), (020), and (002) planes of H₂Ti₂O₅.H₂O. In comparison with static-condition, increment in rotational speed results in higher peak intensity, indicating the enhancement of crystallinity of the product, especially at the characteristic 20 peak at 10°. It is also interesting to observe that at lower rotation speed, the obtained products show distinct separation between liquid solution and solid products, while under intense agitation, an intimate mixture of solid and liquid is observed, similar to colloidal suspension.

Nitrogen adsorption analysis was also carried out to confirm the morphology of the as-synthesized titanates. All samples exhibited pore diameter centered at around 4 nm, which confirms the presence of mesopores. The surface area obtained is near or larger than 100 m²/g even without ion substitution with H⁺. Such high surface area serves as another indication of nanotube formation instead of nanowire, characterized by much lower surface area (less than 50 m²/g).

In summary, by agitation of solution inside the autoclave using magnetic stirrer, high aspect ratio titanate nanotubes with average length exceeding 10 μm were synthesized via hydrothermal method in oil bath; such length scale is orders of magnitude higher than the reported value in the literature. The general mechanism for the formation of multiwall titanate nanotubes involves wrapping and folding of the intermediate nanosheets. It is proposed that rotation of magnetic stirrer inside the autoclave creates spiral mass flow pattern, which promotes the gradual attachment of TiO₆ octahedra to the end of the small length-scale titanate nanotubes along the mass flow direction, thus enlarge the length scale of the final titanate nanotubes. Since bundle-like secondary structure formed at more intense rotation speed of 1000 rpm, leading to undesirable reduction on surface area, all subsequent experiments were carried out using a rotation speed of 500 rpm.

Effect Of Time

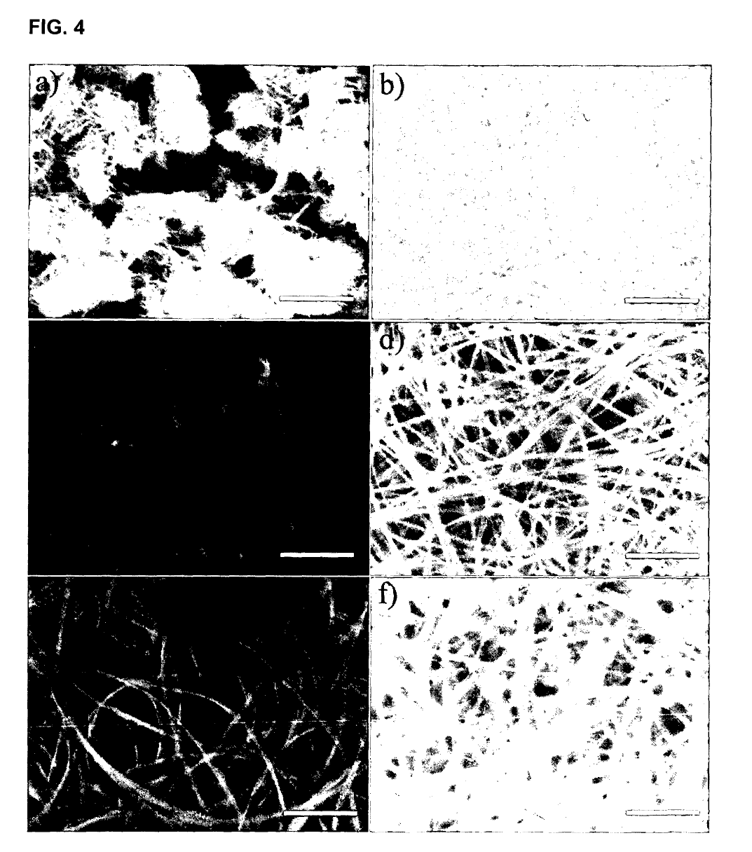

To further investigate the mechanism of high aspect ratio nanotube formation, reaction was carried out at 130° C. with different duration and the morphologies are shown in FIG. 4. Transformation from anatase TiO₂ to titanate starts from as early as 2 h, with titanate nanotubes bridged and grafted among particles. Such a fast reaction can be attributed to intense mixing within the autoclave, which improves the contact area of reactants. When reaction was carried for 4 h, titanate nanotubular structure starts to dominate the morphology of products. After 16 h of reaction, the obtained products show clearly long and entangled nanotubular structure, which become comparable to that of 24 h. However, it was observed that further increment of reaction time causes straightening of the nanotubes; in addition, the nanotubes starts to be aligned in a parallel fashion into bundle-like secondary structures.

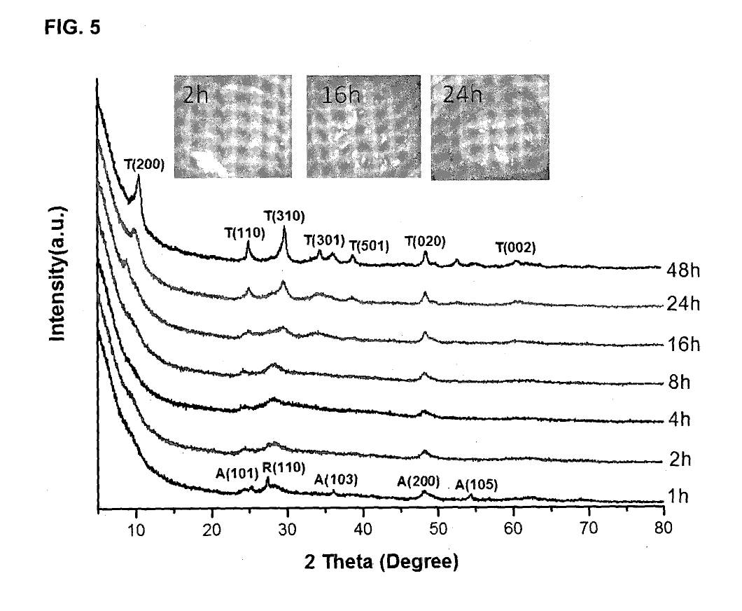

The crystalline structures of the products were accessed via XRD spectroscopy and the spectra are presented in FIG. 5. The sharp peak around 27° at 1 h belongs to rutile titanium dioxide. There are no strong peaks for anatase titanium dioxide, indicating that anatase reacts faster during the process. The disappearance of titania peaks at 2 h confirms phase transformation, as observed from the SEM images. When reaction was carried out continuously for 16 h, the peak at 10° becomes sharper and stronger, together with the elimination of titania peaks, indicating that the reaction was completed after 16 h. Further increase of reaction time (exceed 48 h) results in stronger and shaper reflection peaks as a sign of transformation into nanowires, which can be seen from the peaks at 25° and 31° as well as a new peak at 35°. For the final products inside autoclave, the solution showed distinct separation of solid/liquid phases for up to 8 h, but if the reaction was extended for longer than 16 h, intimate mixture was observed, which serves as a sign for the formation of high-aspect ratio, entangled nanotubular structure.

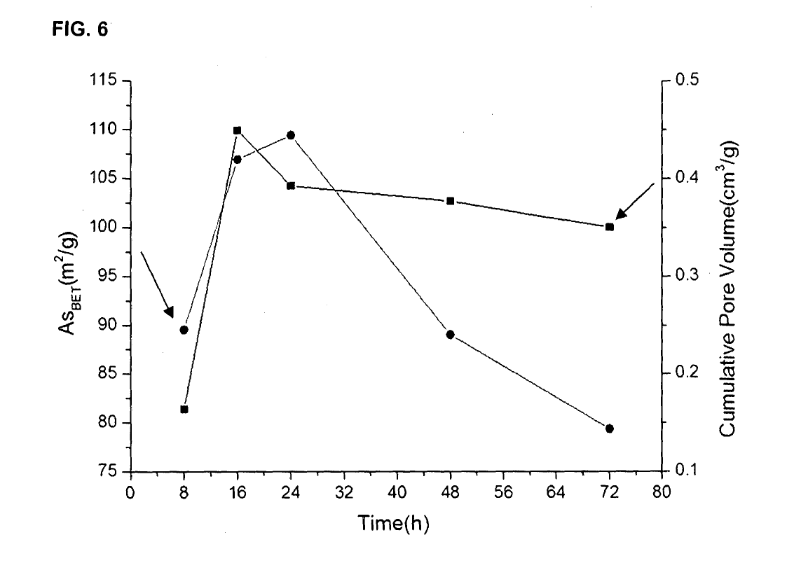

The pore structure of the samples synthesized at different time was probed by nitrogen adsorption, as reported in FIG. 6. In the first 24 h, the specific surface area increases to 109 m²/g. The BET surface area starts to drop with prolong synthesis duration and reach a value of 79 m²/g after 72 h. The cumulative pore volume exhibits a similar trend. Both phenomena serve as indication of transformation from nanotube to nanowire structure, as observed in the SEM images. The increase in specific surface area corresponds to formation of hollow nanotubes from starting materials, whereas reduction on the surface area reveals transformation into agglomerated nanowire-like structure.

Thermodynamically, titanate nanotube is a metastable, and transformation into nanowires will take place spontaneously to reduce surface area and the overall Gibbs free energy. In this hydrothermal system, intense mixing inside the autoclave enhances contact among reactants, which may accelerate such transformation. As a result, at prolong reaction time, nanotubes will transform into bundle-like secondary structure and eventually becomes nanowires structures.

Effect Of Temperature

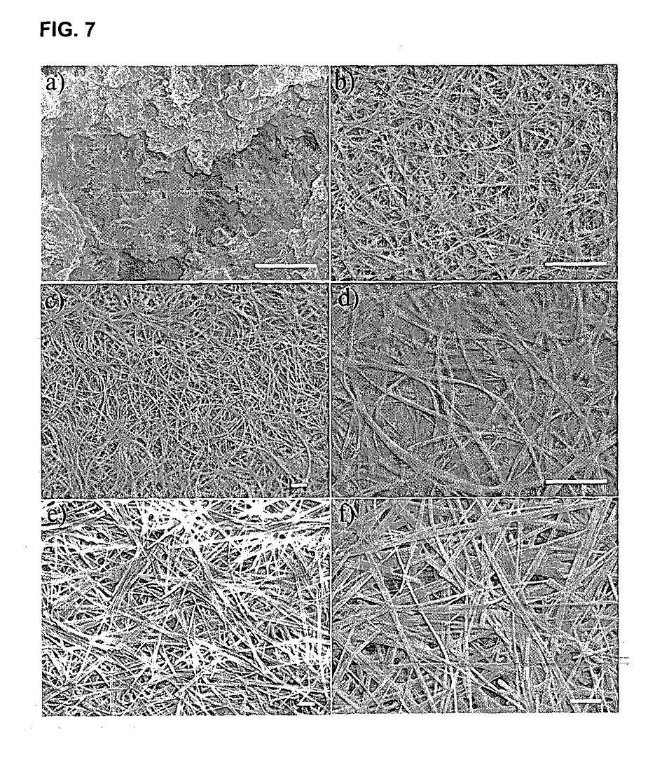

FIG. 7 depicts SEM images of the products reacted at different temperatures. At 60° C., most of the products remained as particles rather than nanotubes. When temperature was increased to 100° C., long entangled nanotubes was found to dominate the morphology of the product. When temperature is higher than 130° C., the obtained products become straight and solid (non-porous), indicating formation of titanate nanowires.

The X-ray diffraction pattern and specific surface area data match well with the transformation observed from SEM images. The raw material will form titanates at 100° C. with low crystallinity. When temperature exceeds 130° C., long and entangled titanate nanotubes start to transform into straight nanowires, and the specific surface area starts to decrease significantly to 32 m²/g at 170° C., which falls into the typical range of titanate nanowires. At higher temperature, much more Ti⁴⁺ dissolve into solution, crystallization of nanosheets becomes too fast to surpass the wrapping of the nanosheets, resulting in more crystalline nanowires.

Multifunctional Properties of Free-Standing Membrane

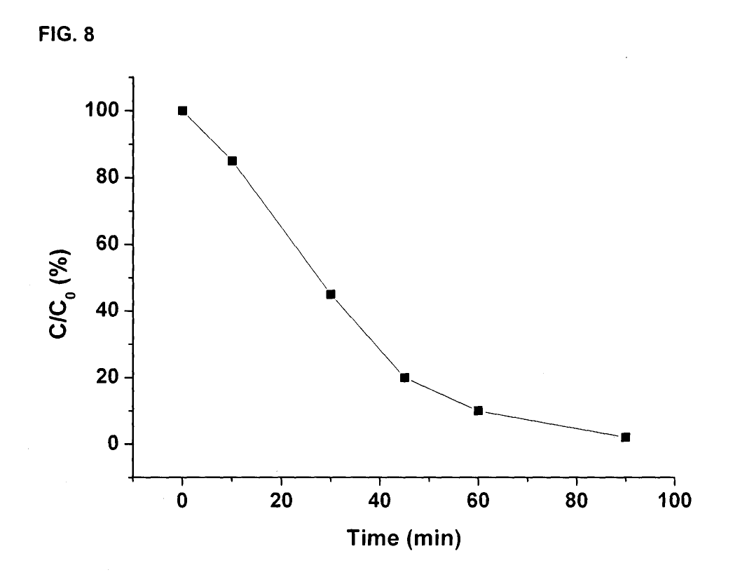

Long and entangled nanostructures are suitable for fabrication of membranes. For instance, ultra long manganese oxide nanowires have been made into free-standing membrane, which exhibited excellent absorption properties for oils. Carbonaceous nanofiberous membranes have also been utilized for filtration and separation of nanoparticles as well as water purification. The high aspect ratio titanate nanotubes synthesized herein also yields similar properties. After drying, the suspension will form membrane structure, taking the shape of container. In order to control the size and avoid bubble formation inside the membrane, filtration method was utilized to fabricate the multifunctional titania and titanate membrane. Firstly, the titanate membrane was obtained by filtration and then heated at 450° C. for 1 h, generating the titania TiO₂ membrane, and then the titanate membrane was re-filtrated again on titania TiO₂ membrane to obtain the dual layers of multifunctional membranes. The titania TiO₂ can be used as the photodegradation layer, the TiO₂ is active under the UV-visible lamp light (composed of 10% percent of UV light) is active since the concentration of MB is decreased with time and was totally degradated after 90 min (FIG. 8).

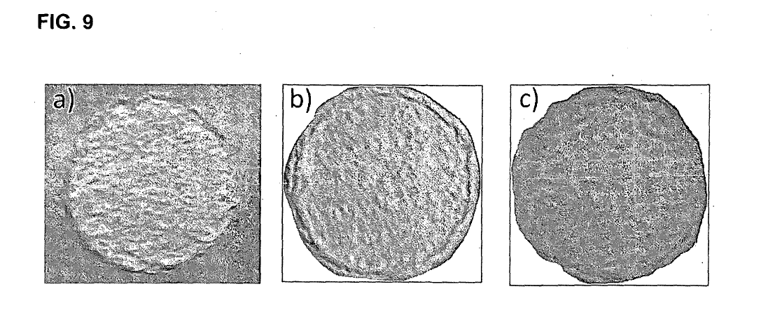

Although the titania TiO₂ can be used as the photodegradation layer, the degradation performance is efficient under UV illumination only. Therefore, it is needed to develop the visible light active layer by functionalization. For the functionalization of the membrane, the Ag/AgCl nanoparticles were introduced. Here, the long and entangled sodium titanate products obtained at 130° C., in 10M NaOH solution, with rotation speed of 500 rpm for 24 h was ion exchanged with Ag to achieve visible light activity. After ion substitution, the Ag-titanate membrane was fabricated and dried in oven for 16 h. As presented in FIG. 9a, the obtained Ag-Titanate membrane shows white color, which is the same as sodium titanate. The Ag contents are 18.22% in weight characterized by SEM-EDX. With the incorporation of ion from the concentrated hydrochloric acid, the newly formed AgCl/Titanate membrane becomes light yellowish (FIG. 9b). When exposed to UV light, silver nanoparticles will precipitate out and the resulting Ag/AgCl/Titanate membrane becomes grey in color, as shown in FIG. 9c.

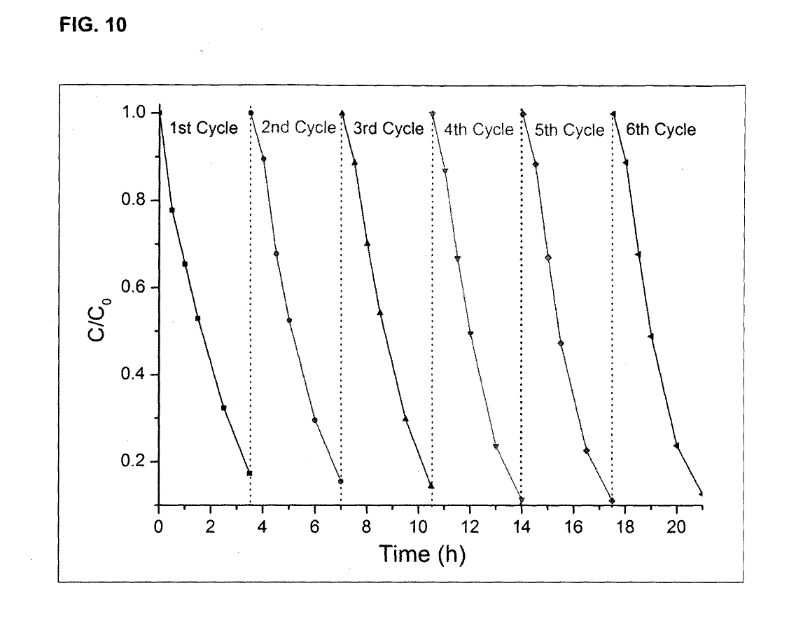

Photocatalytic activity of the Ag/AgCl/Titanate membrane was shown in FIG. 10. Experiments under dark and visible light illumination (>420 nm) were performed to distinguish contribution of adsorption and degradation. The membrane shows little adsorption of MB in dark, but displays good degradation performance under light illumination. This can be attributed to the activation of surface plasmonic resonance of silver nanoparticles. Upon visible light irradiation with certain wavelength, free electrons and holes will be induced around silver particles. Then the excess holes migrate towards the surface of the hybrid Ag/AgCl/titanate photocatalyst for the oxidation of MB. Cyclic runs have shown excellent photoactivity for the membrane without deterioration of performance even after 6 cycles. In addition, the membrane itself is able to maintain the compact structure after all the cycles, indicating its robustness in the aqueous solution of methylene blue.

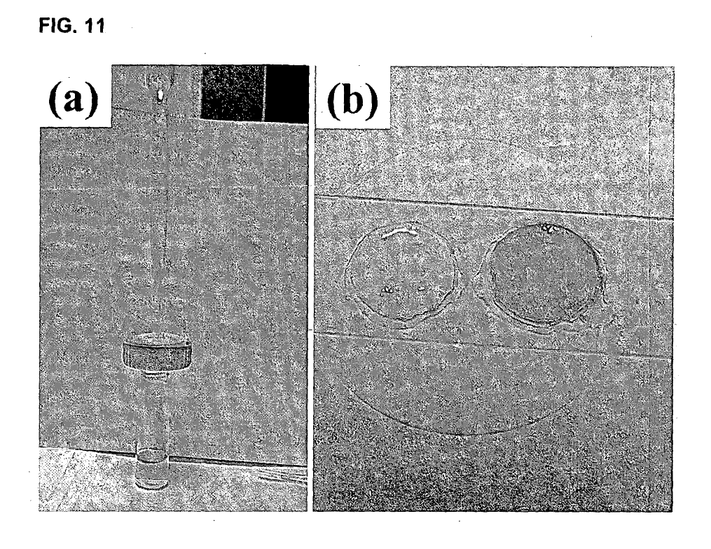

The multifunctional membrane for removing the toxic metal ions is also tested, and Fe³⁺ is selected as the target due to the easy observation of its color. The experimental setup is shown in FIG. 11a, and the experimental result is shown in FIG. 11b. From FIG. 11a, it can be observed that the orange color Fe³⁺ ions solution become colorless after passing through the titanate membrane, and the pristine white color of titanate membrane become orange color, which is due to the ion-exchange process.

Conclusion

Here, a modified hydrothermal method was employed to synthesize high aspect ratio titanate nanotubes with average length greater than 10 μm, which is orders of magnitude longer than reported values in the literature. Rotation speed greater than 500 rpm yields long and entangled titanate nanotubes due to intense mixing of reactants. At prolonged time, the long and entangled nanotube will transform into straight nanowire-like structure with lower surface area. At elevated temperature, nanowires formation suppresses the formation of nanotube, and the final products were dominated by nanowires. Although titanate nanotubes are at metastable state and tend to transform into more stable state like nanowire, by the creation of directional flow inside the autoclave, we can control the kinetics of the system to obtain the desired nanostructure. Because of high surface area and good crystallinity, the fabricated TiO₂ membrane and Ag/AgCl/Titanate membrane demonstrated good photocatalytic performances under UV light and visible light degradation of MB respectively. The membrane also shows capability to remove metal ions from aqueous solutions. In addition, the membrane can be easily recycled and reused without deterioration of performances. The synthesis method described herein may be applicable to hydrothermal systems other than titanate. It provides a facile strategy to obtain high surface area, high crystallinity and novel morphology nanostructures.

### Example 2

### Correlating Aspect Ratio of Nanotubular Structures with Electrochemical Performance for High-Rate and Long-Life Lithium-Ion-Batteries

Obtaining a fundamental understanding on the relationship between electrode nanostructure and electrochemical performance is crucial in order to achieve high-rate and long-life lithium-ion batteries. Herein, it is reported the correlation of nanostructure aspect ratio with electrochemical performance of lithium ion batteries based on TiO₂ nanotubular materials, whose aspect ratio is systematically controlled by a stirring hydrothermal method such as one described in Example 1.

It was found that aspect ratio of the TiO₂ nanotubes governs electrochemical reactivity in the lithium storage process at the high charge/discharge rates. It is significant to note that a battery comprising nanotubes with high aspect ratio of 265 can retain more than 86% of their initial capacity (133 mAh g⁻¹) over 6000 cycles at the ultra-high rate of 30 C, due to the short lithium diffusion length and low internal/charge-transfer resistance. This represents the best performance reported so far for additive-free TiO₂ based lithium-ion batteries with long-cycle lives. Such energy storage device with supercapacitor-like rate performance and battery-like capacity demonstrates the possibility of attaining high-rate and long-expectancy batteries through optimizing the aspect ratio of nanostructure materials.

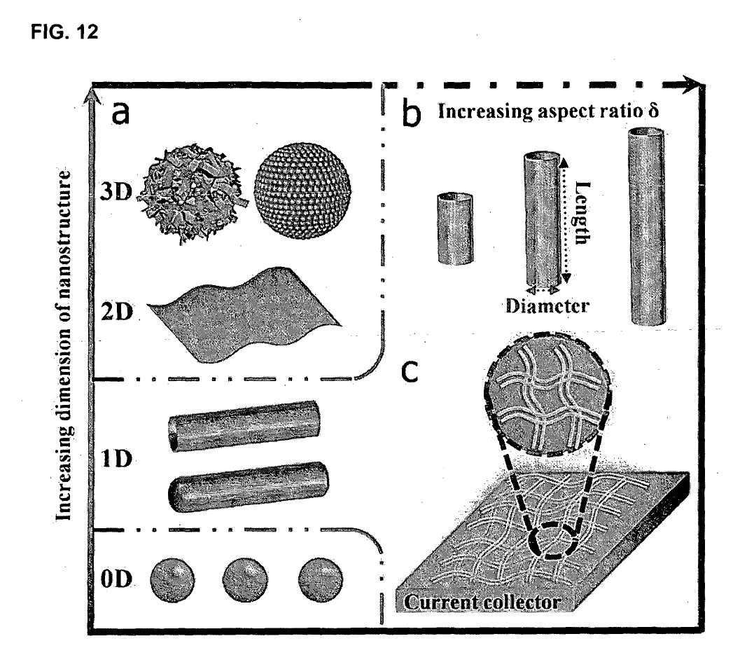

In this example, it is demonstrated a strategy to realize rationally designed gel-like 10 TiO₂-based nanotubes (NTs) through a facile stirring hydrothermal method. The nanotubular structures with different aspect ratios (δ), defined as the length divided by the diameter (FIG. 12b), are rationally synthesized by tuning the agitation condition of the precursor solution. Based on an additive-free nanotubular cross-linked network electrode system (FIG. 12c), the correlation between nanostructure aspect ratio and actual electrochemical performance of lithium ion batteries can be elucidated. It was found that aspect ratio constitutes a critical parameter in determining electrochemical performance at high charge/discharge rate. Based on this, a high-rate and long-life battery with remarkable electrochemical performance can be achieved through the use of high aspect ratio TiO₂ nanotubular structures.

Methods

Material And Synthesis

A commercially available P25 powder (Degussa, Purity 99.8%) was used as the TiO₂ precursor. In a typical synthesis, 0.1 g of P25 powder was dispersed into 15 mL of NaOH solution (10 M) with continuous stirring for around 5 min, and then transferred into 25 mL Teflon-lined stainless-steel autoclave with a magnetic stirrer. The autoclave was placed inside a silicon oil bath on a hot plate with the reaction temperature set at 130° C. for 24 h. By controlling the stirring rates, titanate nanotubes with different aspect ratios were obtained. After reaction, the autoclave was taken out from oil bath and cooled to room temperature. The product, sodium titanate, was collected by centrifugation, washed with deionized water several times to attain a pH value of 9. The wet centrifuged sodium titanate materials were then subjected three times to a hydrogen ion exchange process in a diluted HNO₃ solution (0.1 M). Finally, the suspension was centrifuged again and washed with deionized water several times to reach a pH value of 7, in order to generate hydrogen titanate nanotube materials. To fabricate the battery anode electrode, hydrogen titanate nanotube paste of different aspect ratios were spread on the Cu foil, before undergoing thermal treatment at 500° C. for 2 h in vacuum.

Characterization

The morphologies of the as-synthesized samples were examined by field emission scanning electron microscopy (FESEM, JEOL JSM-6340F). Transmission electron microscopy (TEM, JEOL JEM-2100F) operating at 200 kV was used to further confirm the detailed nanostructures. The powder X-Ray diffraction (XRD) patterns were obtained by Bruker 6000 X-ray diffractometer using a Cu Kα source. Nitrogen adsorption/desorption isotherms were measured at 77 K using ASAP 2000 adsorption apparatus from Micromeritics. The samples were degassed at 373 K for 6 h under vacuum before analysis. The viscosity of the solution was measured at 298 K using a Haake Viscotester VT550 with a SVIIP cup and rotor, and all the aqueous solutions with 50 mL were tested in the same condition under the rotor rate of 100 rpm.

Electrochemical Testing

The electrochemical performance was investigated using coin-type cells (CR 2032) with lithium metal as the counter and reference electrodes. The electrolyte was 1 M LiPF₆ in a 50:50 (w/w) mixture of ethylene carbonate and diethyl carbonate. The cells were assembled in a glove box with oxygen and water contents below 1.0 and 0.5 ppm, respectively. Charge/discharge cycles of titania materials/Li half-cell were tested between 1.0 and 3.0 V vs Li⁺/Li at varied current densities with a NEWARE battery tester. Cyclic voltammetric (CV) test was conducted from 3.0 to 1.0 V using an electrochemical analyzer (Gamry Instruments. Inc). And electrochemical impedance spectroscopy (EIS) test was conducted using an electrochemical station (CHI 660).

Results

Rational Design of 1D Nanotubular Structure

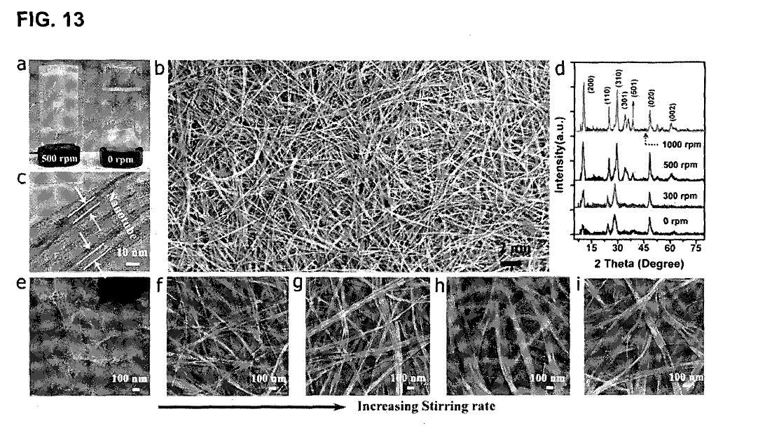

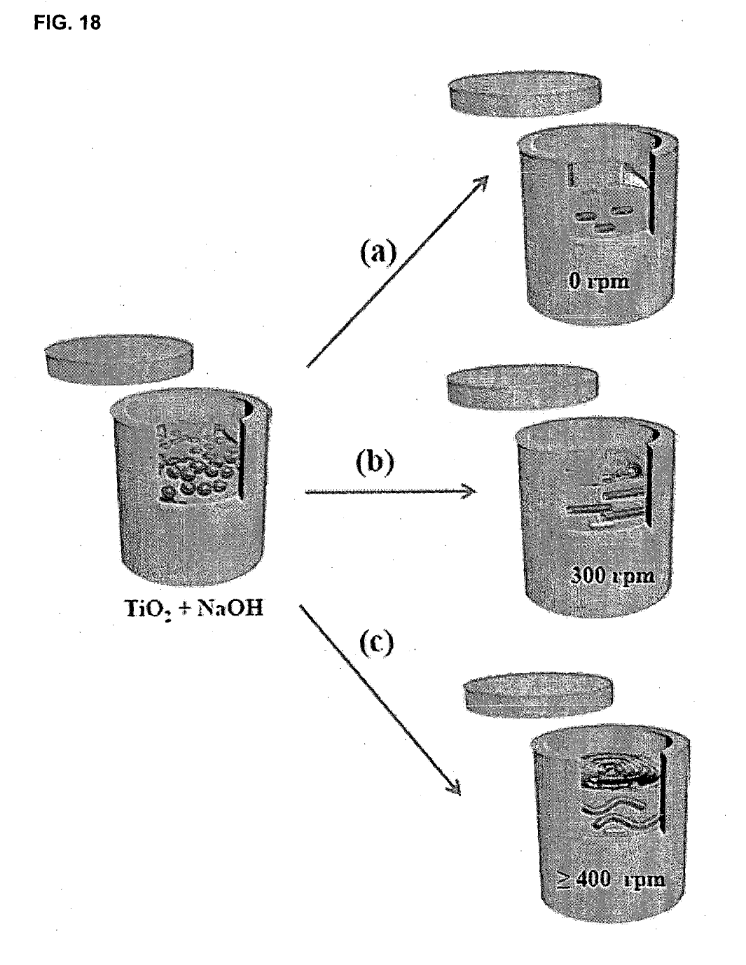

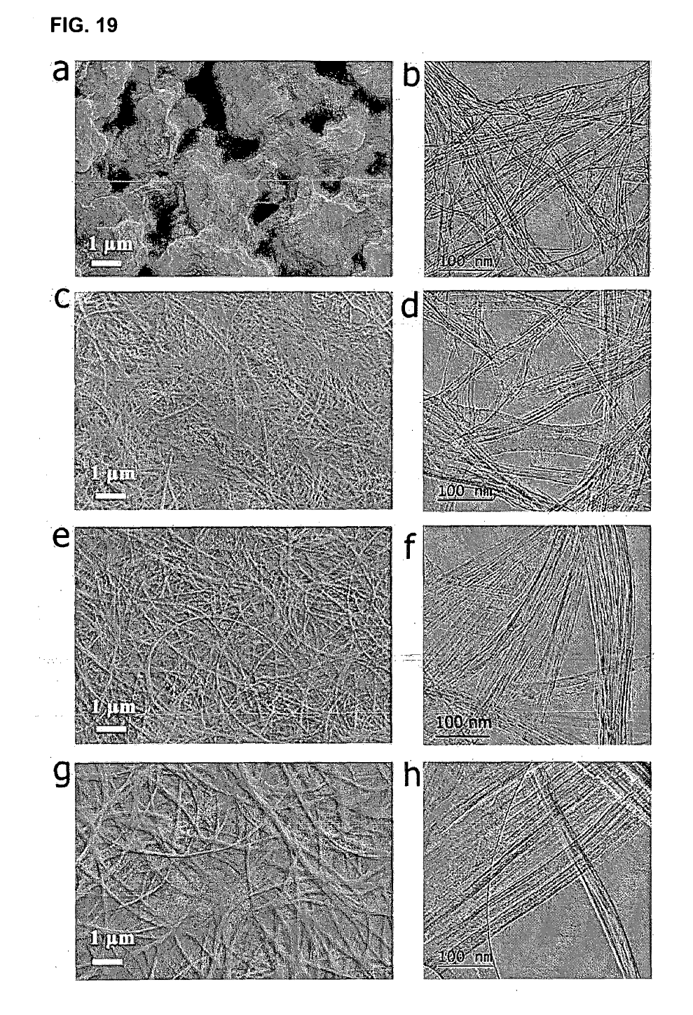

The first step of present strategy is to realize the synthesis of titanate nanotubular structures comprising different aspect-ratios (FIG. 18). Herein, a TiO₂-based material was selected due to its excellent characteristics; such as safety, stable cycling performance, as well as low volume expansion upon lithiation. Traditionally, the separated laminating titanate solution was formed after static hydrothermal reaction, yielding the shorter titanate nanotube due to the limited mass transport and low growth kinetic under the static condition. In order to achieve a viscous titanate solution by cross-link network of elongated titanate nanotube, improvement of the mass transport in the hydrothermal reaction is desired. It was postulated that the aspect ratio of nanostructure can be controlled by tuning degree of “polymerization” of the starting precursor, through modulating the agitation condition of the precursor solution by a stirring hydrothermal method. Present method produced a gel-like mixture (left image of FIG. 13a) by hydrothermal reaction with a stirring speed of 500 rpm. For simplification, the nanotubular samples obtained were denoted as ‘NT-n’, in which n refers to the stirring rate used during hydrothermal reaction. Low-magnification scanning electron microscope (SEM) image in FIG. 13b revealed that the synthesized NT-500 sample was long and continuous; the average length was around 30.7 μm, about two orders of magnitude greater than the literature reported value of titanate nanotubes synthesized under static hydrothermal method and one order greater than that synthesized by the modified hydrothermal method. In addition, the multi-walled nanotubular structure with hollow interior seen in the NT-500 sample (FIG. 13c) can also be observed in the other samples prepared under different stirring speeds (FIG. 19d, f, h). The resultant nanomaterials were confirmed to be crystalline titanate phase by X-ray diffraction (XRD) in FIG. 13d. The peak intensity was greatly improved by increasing the stirring speed, which was due to the stronger X-ray scattering by aligned nanocrystals along the elongated nanotubular structure formed under a higher stirring rate.

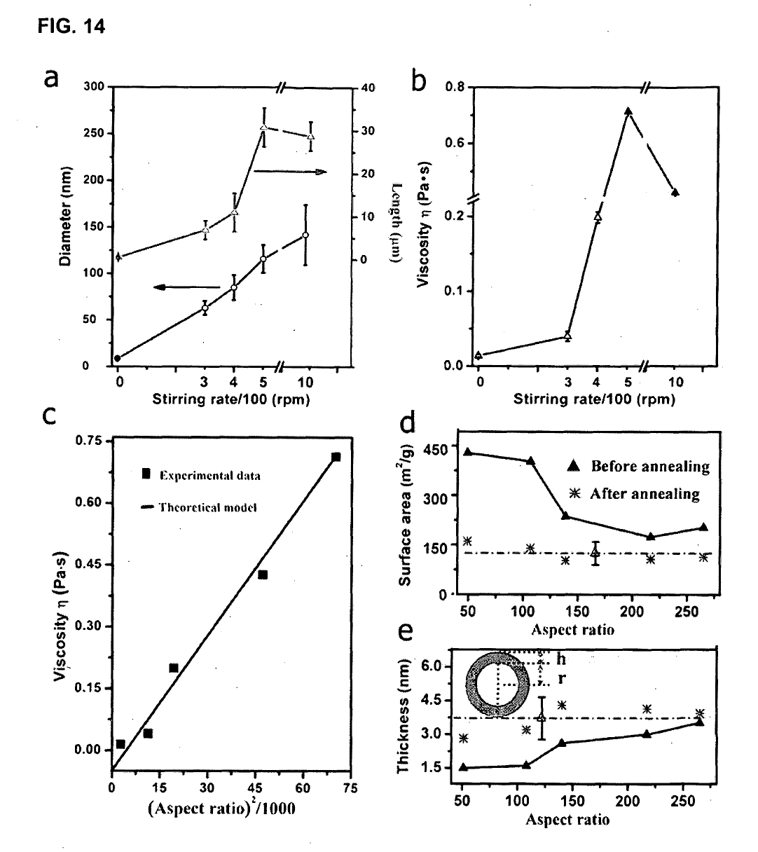

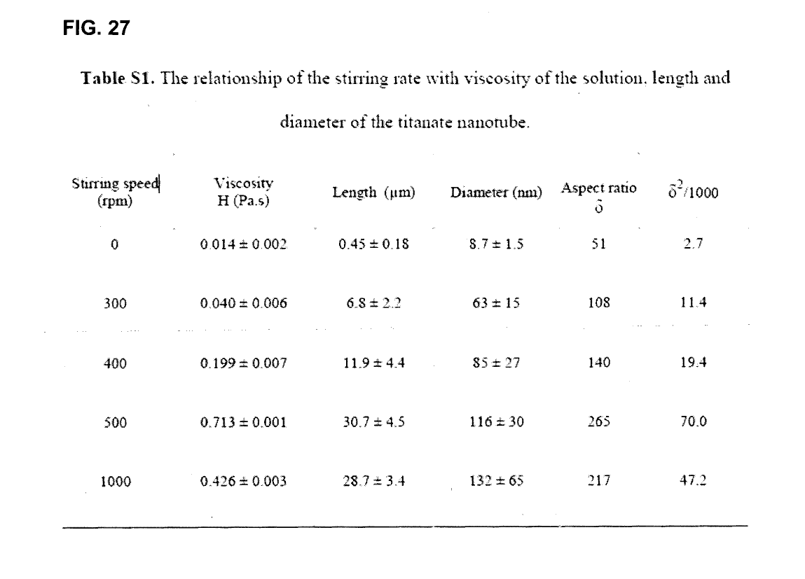

As predicted, the diameter and length of nanotubular structures (FIG. 13e-i, FIG. 14a) can be rationally tailored by mere tuning of the stirring rate, and the resultant nanotubular aspect ratios were summarized in Table S1 in FIG. 27. Under the reaction without stirring (FIG. 18a), the as-synthesized sample NT-0 retained a short length of 0.45±0.18 μm and small diameter of 8.7±1.5 nm (FIG. 19a-b, FIG. 13e and FIG. 14a). When the stirring rate was increased to 300 rpm (FIG. 18b), significant lengthening (6.8±2.2 μm) and widening (63±15 nm) of the nanotube structure was observed (FIG. 13f and FIG. 19c). The increase in tube dimension and aspect ratio of NTs was due to the gradually improved mass transport by mechanical disturbance inside the autoclave, which influenced two important factors for chemical transformation from titania particle to titanate NTs structure: (i) acceleration of the TiO₂ dissolution-recrystallization rate, thus shortening the reaction time; and (ii) facilitation of the attachment between reactants and the ends of short nanotubes, thus elongating the nanotubular structures. The aspect ratio of NTs (FIG. 27, Table S1) and viscosity of the resultant solution (FIG. 14b) was further increased with increasing agitation up till a stirring rate of 500 rpm, after which a decrease was observed at 1000 rpm. It should be noted that the dramatic increase in the viscosity (FIG. 14b) was due to the formation of the gel-like mixture starting at 400 rpm (FIG. 18c), and a correlation can be observed between the aspect ratio (δ) of the nanotube structure and the viscosity of the result solution, as shown in FIG. 14c. The viscous mixture suspensions obtained under stirring can be assumed to be Newtonian fluids, thus a fitting was conducted based on the zero-shear viscosity (η₀) theory. The correlation between the measured viscosity η₀ of the uniform nanotubes dispersion with the aspect ratio δ of a nanotube can be explained through the following:

η₀∝α·δ² (1)

in which α represents the correction factor. It can be seen from FIG. 14c that the experimental data agrees well with the fitting, indicating the existence of a near linear relationship between viscosity and square of aspect ratio.

Electrochemical Performance

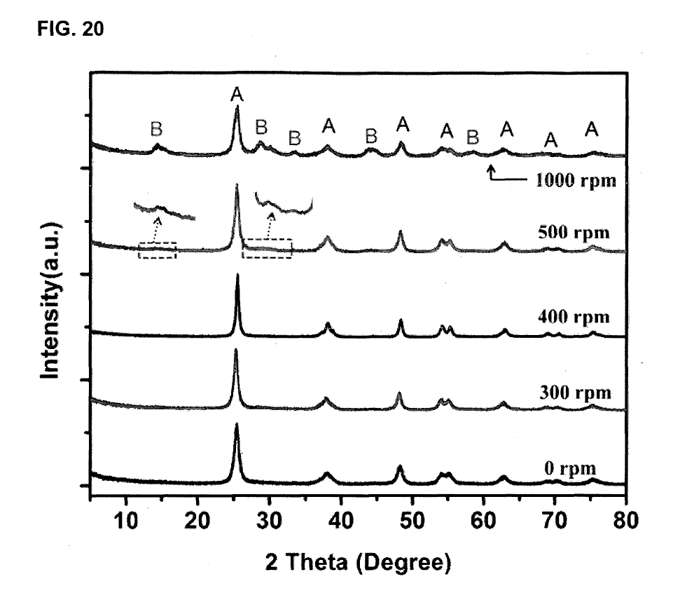

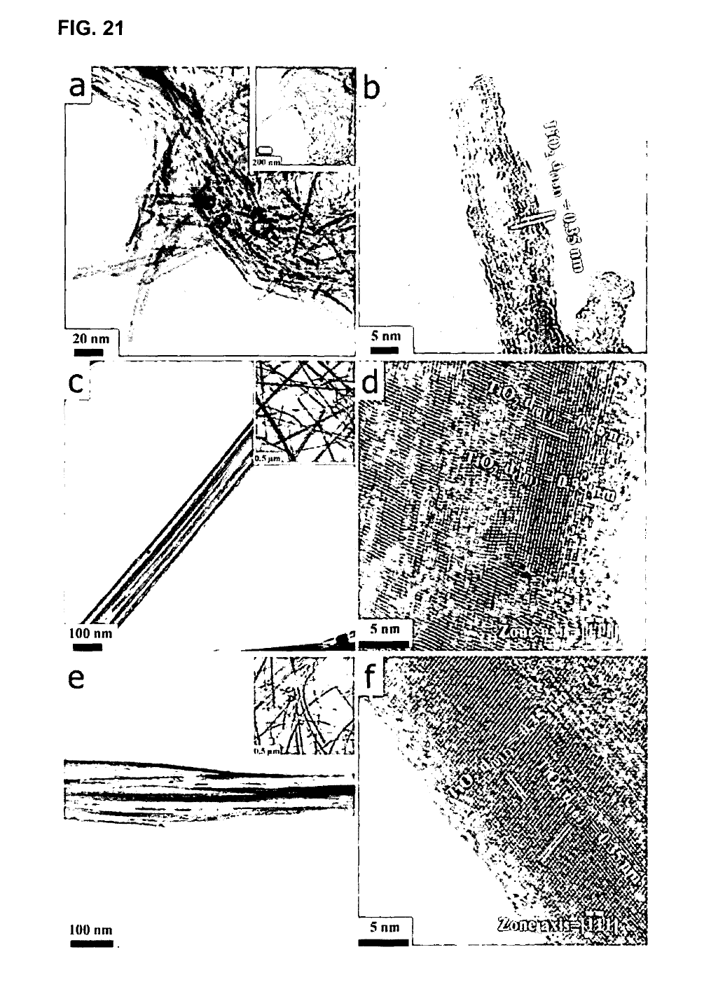

For proof-of-concept experimental studies, additive-free battery cells for electrochemical performance evaluation using the aforementioned titanate nanotubes with different aspect ratios were prepared as follows. Firstly, the titanate nanotube slurry was directly coated onto copper foil and dried under vacuum. The resultant titanate nanotubular electrodes were then subjected to the vacuum thermal treatment, yielding crystalline TiO₂ nanotubular electrodes confirmed by XRD patterns (FIG. 20). Next, the titania nanotubular electrodes were assembled with lithium foil counter electrode to form a coin cell. During the fabrication process, it was found that the TiO₂ nanotubular structure can adhere strongly onto the copper foil current collector even under bending condition, ensuring good physical and electronic contact. This is probably due to the strong van der Waals attractive forces via Ti—O—Cu dangling bonds during the drying process of the colloid-resembling titanate slurry on copper foil. Despite the vacuum thermal treatment which constituted the drying process, the hollow nanotube morphology was observed to be well maintained, and the outer diameter and length of nanotube did not exhibit any obvious changes (FIG. 21). Based on detailed nitrogen adsorption analysis, the specific surface area (S) of the nanotube structure can be estimated through calculation of the geometrical nanotube characteristics (inset of the FIG. 14e) by the following equation:

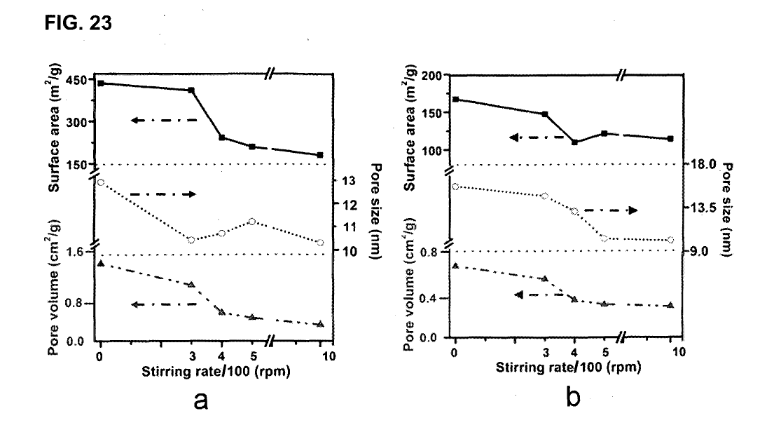

S=2/ρh (2)

where ρ and h refer to the density of TiO₂ materials and the thickness of the nanotube, respectively. From Equation (2), it is evident that surface area is dependent on the nanotube wall thickness rather than the nanotube length. Thus, the decrease in surface area and pore volume (FIG. 23-23) of TiO₂ nanotubular structure after heat treatment may be attributed to the increase of the nanotube thickness (FIG. 14d-e). After thermal treatment, the surface area and average diameter of annealed TiO₂ nanotubular samples with various aspect ratios were found to be within the same range of 132±28 m²/g (FIG. 14d) and 3.7±0.8 nm (FIG. 14e) respectively.

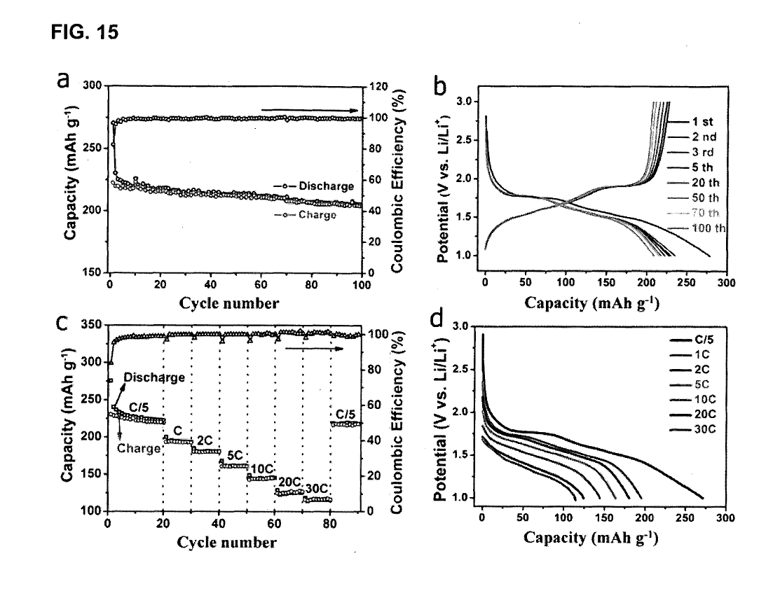

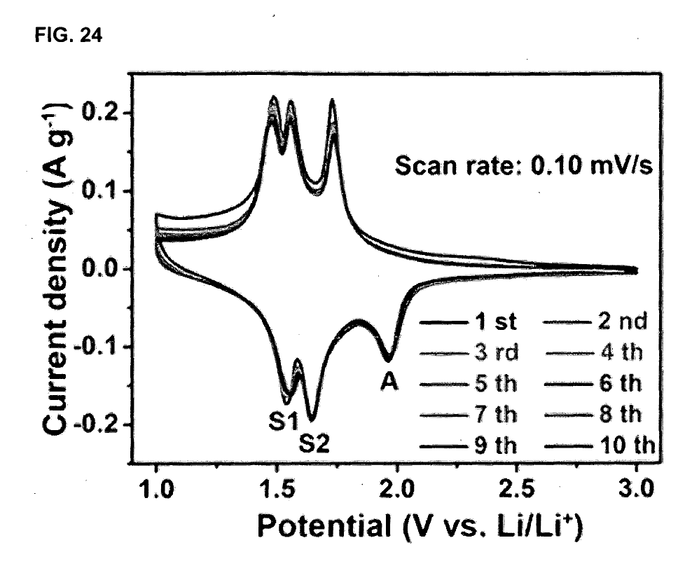

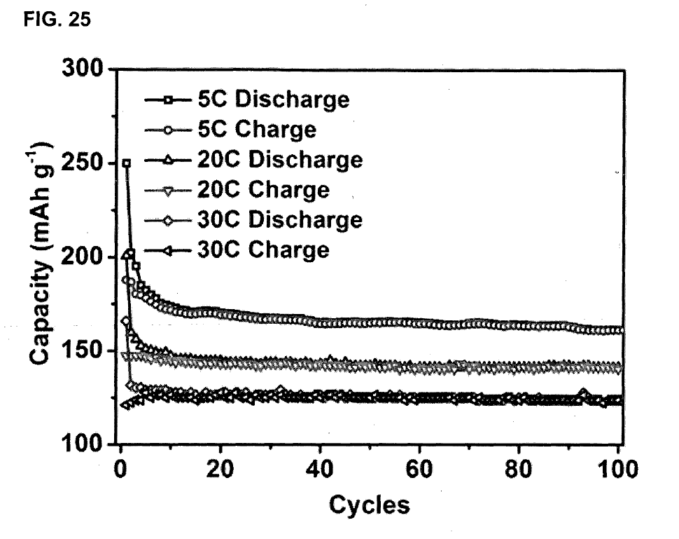

As proof-of-concept, the additive-free TiO₂ NT-500 electrode was employed in a lithium ion cell. FIG. 15a shows the discharge/charge capacity of the NT-500 electrode through 100 cycles at a current density of C/5 (1 C=168 mA g⁻¹), while FIG. 15b provides the corresponding galvanostatic discharge/charge profiles. High discharge and charge capacity of about 273 and 225 mAh g⁻¹, respectively, was exhibited for the first cycle, giving a Coulombic efficiency of 82.5%. This can be rationalized by the formation of the solid-electrolyte interface (SEI) layers, based on the irreversible discharge/charge behavior. In the second cycle, the Coulombic efficiency of the electrode reached 95.6%, and remained above 96.9% in the subsequent 98 cycles. Even after 100 cycles of discharge/charge processes, the capacity of the NT-500 electrode was retained near 200 mAh g⁻¹ with a Coulombic efficiency of ca. 100%. Cyclic voltammetry (CV) measurement (FIG. 24) provided insight into the redox reaction, revealing the characteristic lithium intercalation behavior of anatase and TiO₂(B) phase in NT-500 sample. No clear change was observed in the CV curves after four cycles (FIG. 24), indicating stability of the storage and release of the lithium ion in NT-500. The rate capability performance (FIG. 15c) of the additive-free NT-500 electrode showed the slow decrease of discharge capacity from 222, 193, 181, 161, 145, 126 to 116 mAh g⁻¹ with the dramatic increasing current-rate ranging from C/5, C, 2 C, 5 C, 10 C, 20 C to 30 C respectively with a high Coulombic efficiency greater than 96% (FIG. 15c). The capacity could be reversibly converted back to 218 mAh g⁻¹ once the rate was set to C/5 again, revealing that 98% of the initial capacity at C/5 was recovered. The discharge profiles of NT-500 electrode in FIG. 15d also confirmed the slight decrease of the capacity when the discharge rate was increased from C/5 to 30 C. In addition, the stable cycling performance of the NT-500 electrode at higher current densities (FIG. 25) proved the good tolerance of ultrafast lithium ion insertion and extraction, indicating the excellent rate capability of the material.

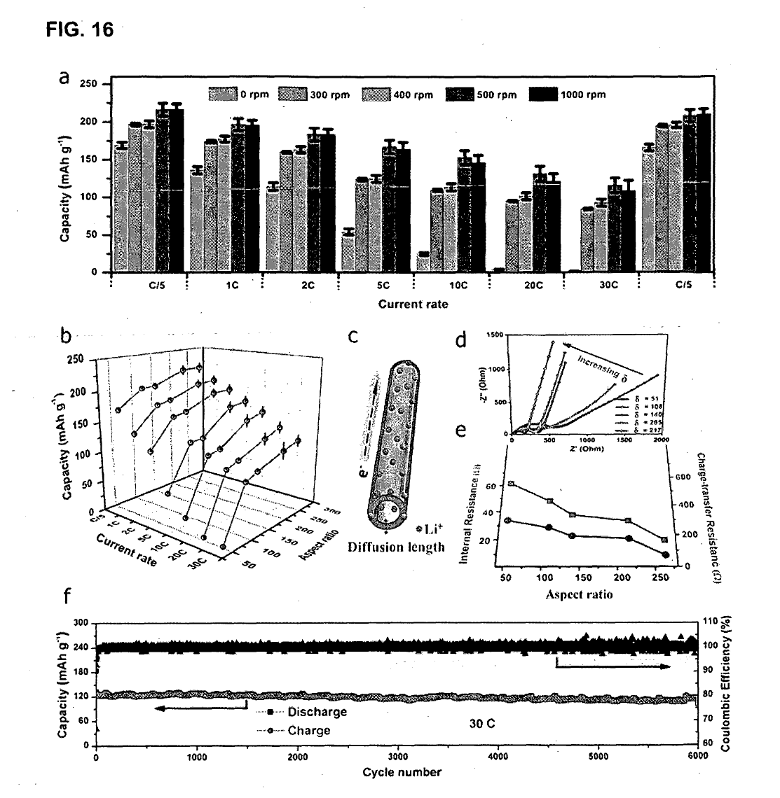

Herein, it has been demonstrated that the TiO₂ NTs material is suitable for additive-free battery application owing to its outstanding electrochemical performance. Based on the same configuration, the correlation between aspect ratio of nanotubular structures and its electrochemical performance was systematically studied, and the results shown in FIG. 16. Statistical study of rate performance of the additive-free TiO₂ electrodes with various aspect ratio δ is conducted at each current density based on discharge capacity of final cycle with ten cells as one batch. It can be observed that the discharge capacity increases with increasing of stirring rate and saturates at high stirring rates, indicating the nanotubular structures with higher aspect ratio δ tend to exhibit better electrochemical performance (FIG. 16a). At low current rate (C/5), these samples showed little difference between their respective discharge capacities; 169±8, 197±4, 197±10, 216±17, 217±15 mAh g⁻¹ were delivered by NT-0, NT-300, NT-400, NT-500 and NT-1000, respectively. However, the difference in discharge capacities between these samples becomes more obvious with increasing discharge rate, which signified that high aspect ratio nanotubular structures can tolerate ultra-fast extraction and insertion of lithium ions even at a high discharge rate of up to 30 C (FIG. 16b). In particular, the NT-500 electrode with an aspect ratio value of 265 displayed a discharge capacity of 116±20 mAh g⁻¹ at 30 C, while the NT-0 sample (aspect ratio of 51) delivered only 1.4±0.2 mAh g⁻¹.

Mechanism Understanding of Aspect Ratio-Performance Correlation

To determine the key factor controlling the electrochemical performance of 1D nanotubular structures and the way it affects the electrochemical performance, it was first identified specific surface area as a potential key factor. The general perception is that higher surface area of electrode materials normally possesses better electrochemical performance. However, this characteristic does not present a holistic explanation to the observations made in current work. While surface area may improve the electrochemical performance, it did not explain the large difference in performance between the samples. Another possibility was that the titania phase obtained from the dehydration of hydrogen titanate may influence the electrochemical performance. TiO₂(B) phase, possessing a higher capacity than anatase TiO₂, existed in both the NT-500 and NT-1000 samples (FIG. 20). However, limited enhancement of the capacity between NT-500 (about 216 mAh g⁻¹) and NT-1000 (about 217 mAh g⁻¹) samples was observed at a low discharge rate of C/5 (FIG. 16a), despite the greater fraction of TiO₂(B) phase in the NT-1000 sample. In addition, a step increase phenomenon was observed from NT-0 (about 169 mAh g⁻¹) to NT-300 or NT-400 samples (about 197 mAh g⁻¹) of pure anatase phase, as well as from the NT-400 sample to NT-500 sample. Therefore, it is believed that the step enhancement of the electrochemical performance was mainly attributed to the formation of elongated structure of larger aspect ratio obtained under a higher stirring rate, rather than phase difference or surface area.

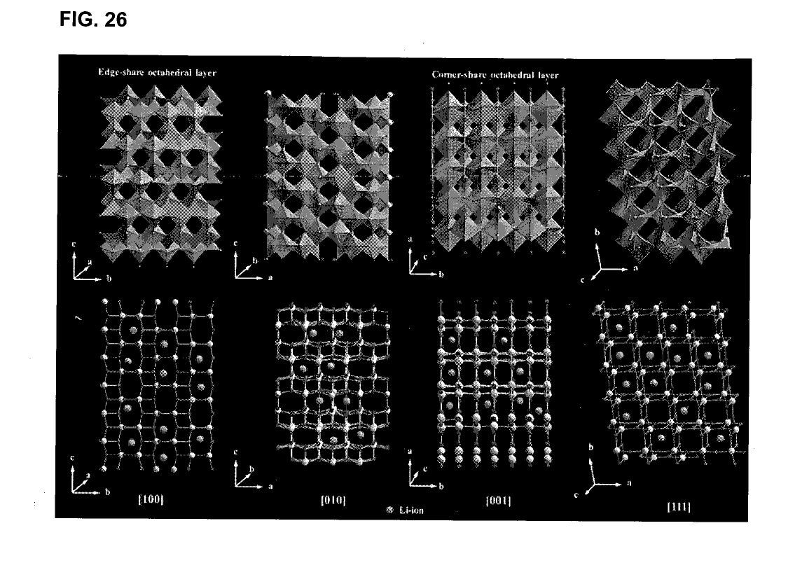

Next, investigation was made to find out how the aspect ratio of 1D structures influenced lithium ion and electron transport, and in turn affect electrochemical performance. It was of great significance to note that the calculated average tube thickness of these TiO₂ nanotubular structures was within 10 nm (FIG. 14e, red dot curve). According to the following calculation, the characteristic diffusion time (t) was far below 1.0 s along the axial direction and more than 10⁴ s along the radial direction with 1 μm length:

$$t \approx \frac{{l}^{2}}{α} \qquad ( 3 )$$

in which l represents diffusion length and α ion diffusivity (α is about 10⁻¹² cm²·s for titania materials). Thus, the Li⁺ ion diffusion pathway traversed along the axial direction of nanotube (FIG. 16c), and the thin tube thickness facilitated rapid lithium ion and electronic transport under the ultrafast charging and discharging process. It was shown previously that lithium ion diffusion in anatase was lowly anisotropic compared to the rutile phase, and that the Li⁺ ion can diffuse along different planes in anatase despite the difference in diffusion energy barriers in different directions. For our sample, thermally stable {101} plane of anatase TiO₂ was observed (FIG. 21) after thermal treatment. According to present model (FIG. 26), Li ion can be easily diffused into the {101} plane along the <111> direction as the TiO₆ octahedral was arranged in this direction, leaving an empty zigzag channel in three dimensional networks of anatase TiO₂, which facilitates fast Li⁺ ion deintercalation/intercalation. The model in FIG. 26 also indicates possible Li⁺ ion diffusion pathway in other directions through the void channel. Therefore, the Li⁺ ion can be rapidly diffused within the thin tube thickness of the TiO₂ nanotubular structure in various directions, resulting in the highly reversible capacity at high rate of 30 C (120 s). However, a huge difference in capacity was observed between nanostructures of different aspect ratio (FIG. 16b), with the capacity drop being particularly serious for the low aspect ratio samples at high discharging rate (FIG. 16b). This led to the hypothesis that the electronic/ion transport in electrode and electrolyte should be a limiting factor accountable for this difference.

The ionic and electronic resistance of electrode materials was also tested through the electrochemical impedance spectroscopy (FIG. 16d-e). It can be seen that each Nyquist plot consists of a high-medium frequency semicircle and a linear Warburg region. The high-frequency region was characteristic of internal resistance, which consisted of the resistance at the electrode/electrolyte interface, separator, and electrical contacts. The internal resistance decreased with the increase in aspect ratio, which indicated that high aspect ratio samples possessed only a minor interface resistance, which facilitated the efficient electronic transport along the axial direction (FIG. 16c). The medium-frequency region was associated with the charge-transfer resistance related to lithium-ion interfacial transfer, coupled with a double-layer capacitance at the interface. It can be clearly seen that the charge-transfer resistance also decreased with aspect ratio, indicating the decreased ionic resistance and enhanced kinetics for high aspect ratio samples. Overall, the short lithium diffusion length and low internal/charge-transfer resistance have allowed preparation of a long life electrochemical energy storage system with supercapacitor-like rate performance and battery-like capacity based on high aspect ratio nanotubular structure disclosed herein. The additive-free TiO₂ nanotubes anode material had an initial capacity of 133 mAh g⁻¹ at high rate of 30 C (FIG. 16f), and the electrode exhibited good stability for up to 6000 cycles while retaining 86% capacity at high discharge/charge rates.

Discussion

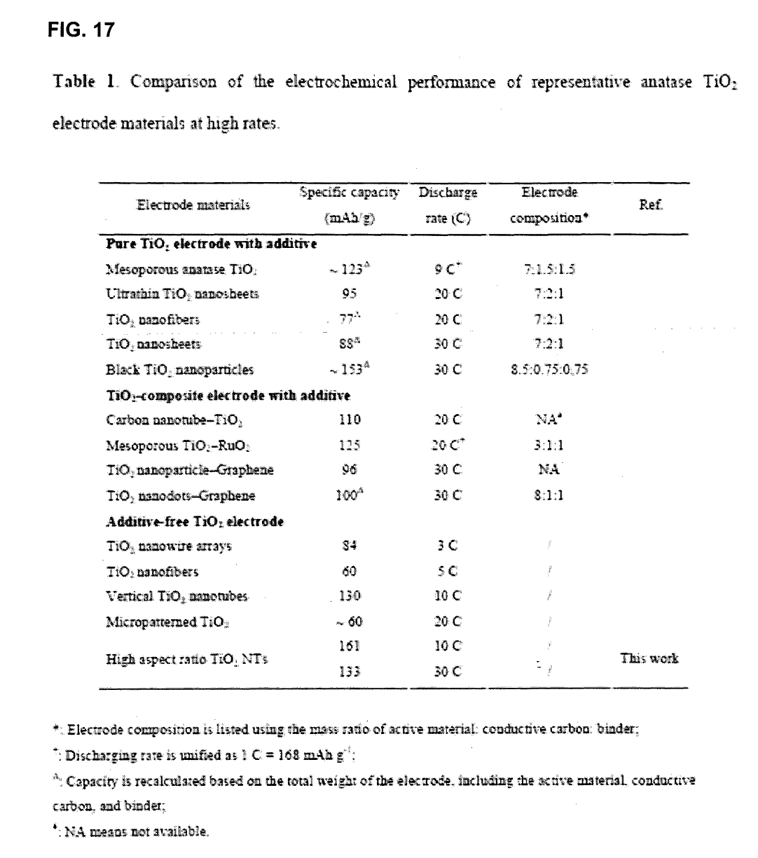

LIBs based on additive-free TiO₂ nanotubes of high aspect ratio, exhibiting remarkable high-rate and long-life were successfully fabricated. This can be attributed to the following three key characteristics. Firstly, the hydrogel-like behavior of the high aspect ratio nanotubes ensured good adhesion between the electrode materials with the current collector, effectively minimizing the internal/charge-transfer resistance. Secondly, the elongated 10 nanotubular structure enabled direct and rapid pathways for the electron and ion transport. Finally, the TiO₂ nanotube, possessing high surface area with a thin tube thickness below 5 nm, offered larger contact surface with the electrolyte solution and reduced lithium diffusion length. Through exploiting these merits, high conductivity and short diffusion path of additive-free electrode were achieved in the current work, which fulfilled the requirement of ultrafast charging/discharging LIBs. It is worth noting that the material disclosed herein exhibited the best performance for additive-free TiO₂ based LIBs thus far (FIG. 17, Table 1), and it was comparable with that of the highest reported value for pure TiO₂ electrodes or its composite electrodes with conductive carbon or polymer binder additives.

In summary, it has been demonstrated herein a novel strategy to rationally synthesize 1D nanostructure materials with different aspect ratios by a stirring hydrothermal method via simple tuning of the stirring rate. A direct correlation between aspect ratio of nanostructure and its electrochemical performance was revealed for the first time, based on a binder- and carbon-free electrode system. An intrinsic parameter, the aspect ratio of 1D nanostructure, was found to be a critical factor in realizing the high electronic/ionic transport properties of additive-free electrode materials; an outstanding electrochemical performance with ultra-long cycling capability of over 6000 charge/discharge cycles has been demonstrated with a high aspect ratio nanotubular structure at the high rate of 30 C. This fundamental understanding would be extremely useful in the development of efficient energy devices by exploiting the merit of unique nanostructures.

### Example 3

### Mechanical Force-Driven Growth of Elongated Bending TiO₂-Based Nanotubular Materials for Ultrafast Rechargeable Lithium-Ion Batteries

In this example, a robust 3D network architecture with anti-aggregation property for long-time cycling was developed through assembly of continuous 1D TiO₂(B) nanotubes, which provided (i) direct and rapid ion/electron transport pathways and (ii) adequate electrode-electrolyte contact and short lithium ion diffusion distance comparing with other nanostructures.

Herein, a protocol to rationally grow elongated titanate nanotubes with length up to tens of micrometers by a stirring hydrothermal method was proposed. This confirmed that the mechanical force-driven stirring process synchronously improving the diffusion and surface reaction rate of titanate nanocrystal growth in solution phase, was the reason for lengthening the titanate nanotubes via an oriented attachment mechanism.

Furthermore, as a proof-of-concept, LIB devices based on TiO₂(B) nanotubular cross-link network electrode materials, thermally-derived from the elongated titanate nanotube, exhibits superior electrochemical performance with high-rate capacity and ultralong-cycling life. This protocol to synthesize elongated nanostructures can be extended to other nanostructured systems, opening up new opportunities for manufacturing advanced functional materials for high-performance energy storage devices.

Experimental Section

Materials And Synthesis

In a typical synthesis, 0.1 g of P25 powder was dispersed into 15 mL of NaOH solution (10 M) with continuous stirring for 5 min, and then transferred into 25 mL Teflon-lined stainless-steel autoclave with a magnetic stirrer. The autoclave was put inside a silicon oil bath on a hot plate and the reaction temperature was set at 130° C. for 24 h. The mechanical disturbance condition can be controlled by tuning the stirring rates. After reaction, the autoclave was taken out from oil bath and cooled to room temperature. The product, sodium titanate, was collected by centrifugation, washed with deionized water for several times to reach a pH value of 9. After that, the wet centrifuged sodium titanate materials were subjected to a hydrogen ion exchange process in a diluted HNO₃ solution (0.1 M) for three times. Finally, the suspension was centrifuged again, washed with deionized water for several times until a pH value of 7 was reached, generating the hydrogen titanate nanotube materials.

Characterization

The morphologies of the as-synthesized samples were examined by field emission scanning electron microscopy (FESEM, JEOL JSM-6340F). Transmission electron microscopy (TEM, JEOL JEM-2100F) operating at 200 kV was used to further confirm the detailed nanostructures. The powder XRD patterns were obtained by Bruker 6000 X-ray diffractometer using a Cu Kα source. Nitrogen adsorption/desorption isotherms were measured at 77 K using ASAP 2000 adsorption apparatus from Micromeritics. The samples were degassed at 373 K for 6 h under vacuum before analysis.

Electrochemical Testing

The electrochemical performance was investigated using coin-type cells (CR 2032) with lithium metal as the counter and reference electrodes. To make the working electrode, the titanate nanotube paste was firstly prepared by dispersing the as-prepared titanate nanotube in ethanol solution (99%) with a concentration of about 4 to 6 mg/mL. After the intensive mixing or stirring, the paste was spread on the Cu foil and then subjected to thermal treatment at 400° C. for 2 h in vacuum. The electrolyte was 1 M LiPF₆ in a 50:50 (w/w) mixture of ethylene carbonate and diethyl carbonate. The cells were assembled in a glove box with oxygen and water contents below 1.0 and 0.5 ppm, respectively. Charge/discharge cycles of titania materials/Li half-cell were tested between 1.00 and 3.00 V vs Li⁺/Li at varied current densities with a NEWARE battery tester. Cyclic voltammetric (CV) test was conducted from 3.00 to 1.00 V using an electrochemical analyzer (Gamry Instruments. Inc). The electrochemical impedance spectroscopy (EIS) test was conducted using an electrochemical station (CHI 660).

Discussion

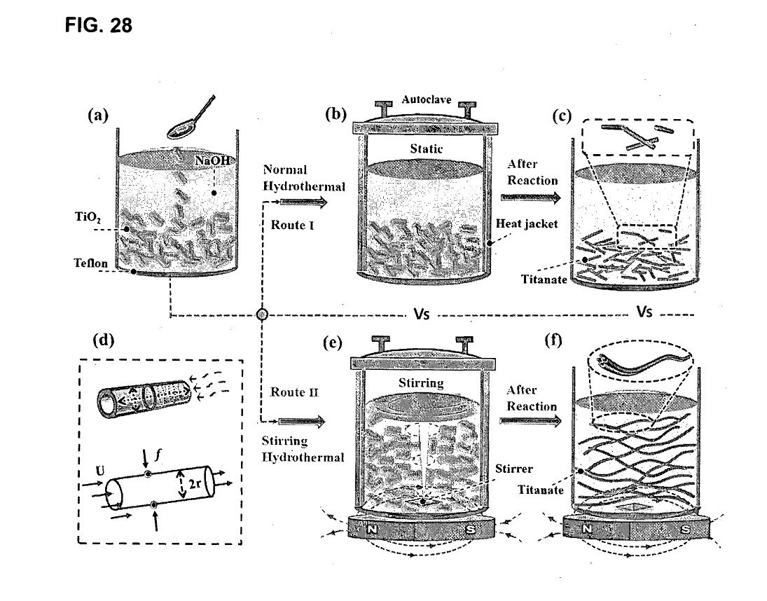

Generally, overall rate of formation of titanate nanotube was controlled by the rates of diffusion and chemical reaction between titania precursor and sodium hydroxide. Under the conventional hydrothermal process (Route I in FIG. 28a-c), short nanotube with several hundreds of nanometers in length (FIG. 28b-c) was obtained due to the slow dissolution-recrystallization process and low growth kinetic of nanotube at static condition. The stirring process can provide homogeneous mixing of reactants in solution, increasing reaction rate as well as maintaining same reaction condition like temperature and concentration. Thus, it is able to generate the uniform morphology of product in large scale.

A stirring hydrothermal method (Route II in FIG. 28e-f) was developed, during which the reaction can be achieved on a normal hot plate magnetic stirrer which provides heating and mechanical stirring simultaneously without reconstructing the normal hydrothermal setup or utilizing other external apparatus.

The mechanical force has four important functionalities during the synthetic process. Firstly, the mechanical disturbance breaks the dissolution-recrystallization equilibrium of nanotube growth in static condition, accelerating the undersaturation of dissolution regions on the TiO₂ surface. Secondly, the mass transport is significantly improved by intensive mechanical stirring induced by the increase of stirring rate. Benefited from this, gradual attachment of titanate precursor enables the growth of nanotubes in radial and axial directions (FIG. 28d). Thirdly, the formed nanotubes are bent due to the force difference imposed on the nanotube during stirring. Lastly, the constant motion of solution prevents sedimentation and forces the intimate mixing, ensuring the homogeneous hydrothermal reaction to occur so that uniform elongated nanotubes can be produced.

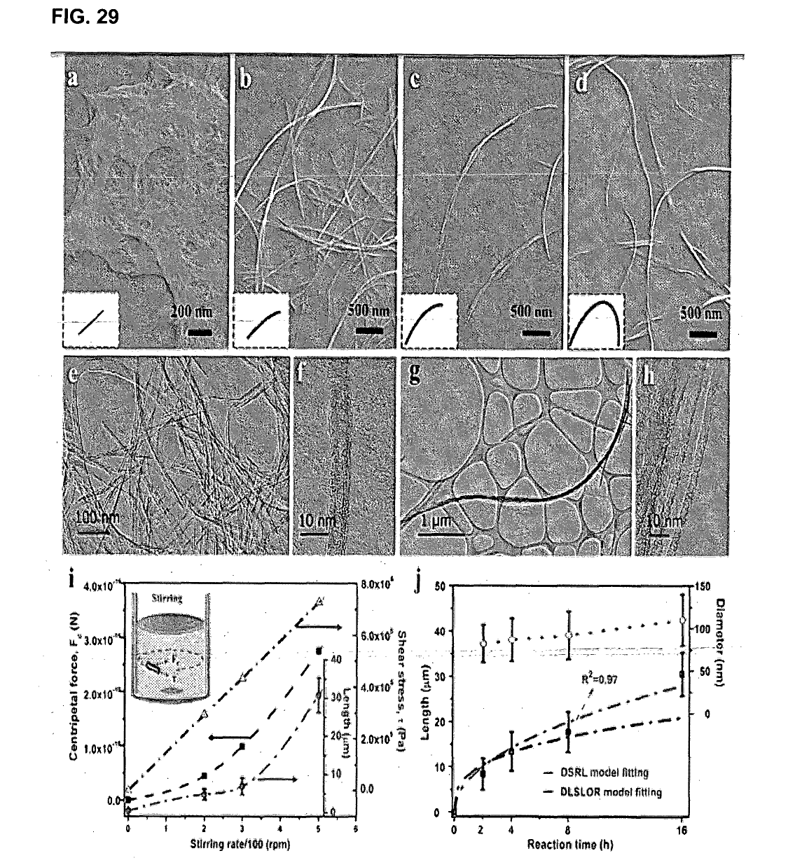

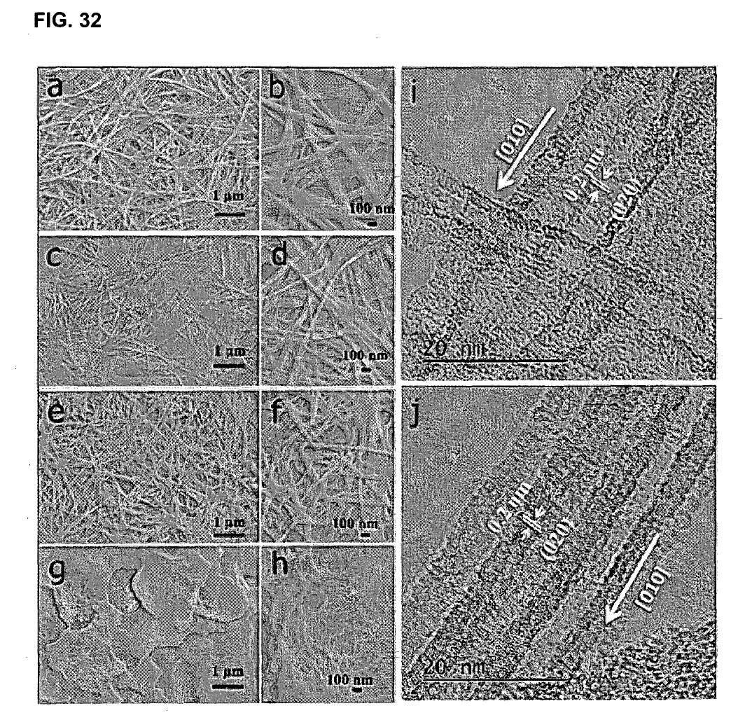

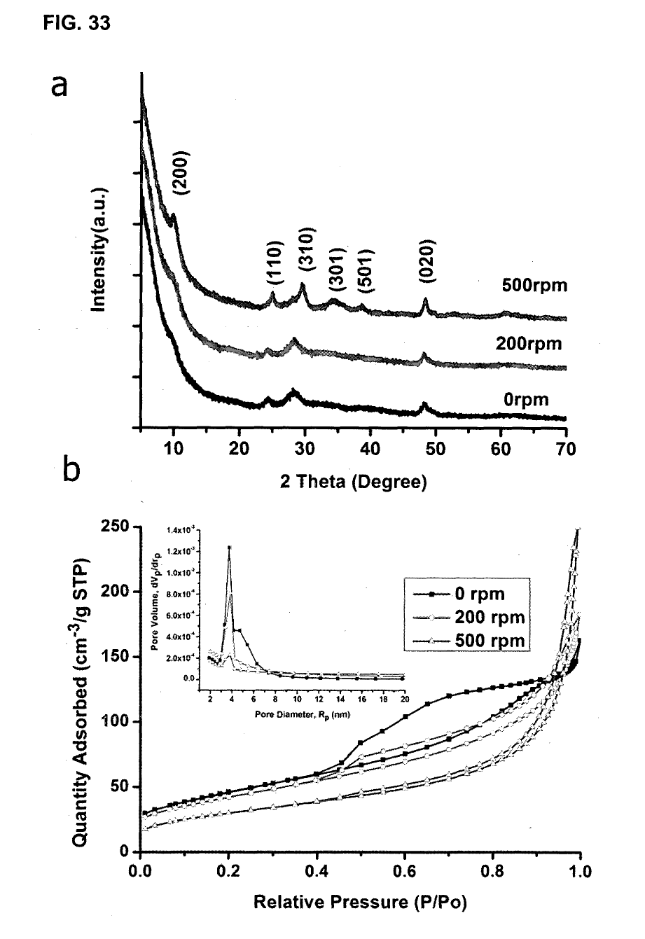

It can be observed an apparent morphology dependence of growth product on stirring rate. As shown in FIG. 32a-h, an obvious increase in diameter and length of resulting 1D titanate nanostructure was observed when the stirring rate was increased. In addition, while a static growth resulted in formation of relatively straight nanostructure, the 1D nanostructure was bent under mechanical stirring, and the degree of bending increased with the increase in stirring rate (FIG. 29a-d and FIG. 32a-h). The as-prepared samples were confirmed to be crystalline orthorhombic titanate phase (FIG. 33a). The transmission electron microscopy (TEM) images in FIG. 29e-h and FIG. 32i-j revealed the formation of nanotubular structure evidenced from the hollow inner part in the axial direction. This was also confirmed by Brunauer-Emmett-Teller (BET) results (FIG. 33b) as the center peak (around 4 nm) of pore size distribution were mainly from the inner space of the nanotube.

) To understand the bending nature induced by mechanical stirring, an idealized system was introduced to estimate the force level applied to the nanotube surface, as shown in FIG. 29i. During the formation of elongated nanotubular structure, the continuous growth of nanotube in stirred viscous solution was subjected to shear stress (τ) and centripetal force (Fc) imposed by the fluid. Firstly, the shear stress on the tube tip was larger than that at other positions located at some distance away from the tip and the effect of side force (fs, FIG. 28d) applied to the nanotube along the axial direction was negligible due to the symmetry effect, which led to bending of the nanotube. From FIG. 29i, it was derived that the shear stress on the tube tip is linearly related to the stirring rate. Hence, when the force applied to the nanotube tip increased, it resulted in the increase of the degree of bending in the nanotube (FIG. 29a-d). Secondly, the centripetal force on the nanocrystal increased proportionally to the square of stirring rate (FIG. 29i). This continuous force acted as a driving force for the titanate precursor and the formed titanate nanotube to align and flow in the same direction without sedimentation. This process accelerated attachment of nanocrystal to the nanotube end to form elongated nanotubular structure as the diffusion and chemical reaction rates were improved at high stirring rate. As demonstrated, the average length of titanate nanostructure increased from 0.4 μm to 30.7 μm (FIG. 29i) when the stirring rate was increased from 0 rpm to 500 rpm. The length of long titanate nanotube formed at 500 rpm was about two orders of magnitude longer than the literature reported value of titanate nanotubes synthesized under static conditions. To further reveal the role of mechanical disturbance in the elongated nanotubular structure growth, growth kinetics under the stirring condition at 500 rpm was studied. Since the growth process of nanotubular titanate via dissolution-recrystallization step was similar to the Ostwald ripening process, it was first considered that the diffusion-limited Ostwald ripening (DLOR model), according to Lifshitz-Slyozov-Wagner theory, to be the sole contributor in the growth mechanism. However, the experimental length (L) data of the titanate nanotube fits well with the DLOR model only for short reaction time, not for long reaction time (FIG. 29j). A further attempt is conducted to fit the L data to the surface-limited reaction model (i.e. L2−t) and the result is also unsatisfactory (not shown). In order to fit the L data of the elongated titanate nanotube, a model which contains both diffusion-limited and surface reaction limited growth (DLSLOR model) was adopted.

BL3+CL2+constant=t,

where B=KT/exp(−Eₐ/k_{B}T) with K∝1/(D₀γVₘ²C_{∞}) and C∝T/(k_{d}γVₘ²C_{∞}).

In which, Eₐ is the activation energy for diffusion; k_{d} is the rate constant of surface reaction; D₀ is the diffusion constant; Vₘ is the molar volume; γ is the surface energy and C_{∞} is the equilibrium concentration at flat surface. This equation not only defines the dependence of the average length L on time t, but also separates out the diffusion and surface reaction terms. A remarkable accuracy (R²=0.97) of fits over the entire range of experimental data by the mixed diffusion-reaction control model is shown by the red curve in FIG. 29j. Thus, the growth of the titanate nanotube deviated sufficiently from the diffusion-limited Ostwald ripening model and followed a mechanism involving both diffusion-control and surface reaction control under the stirring condition.

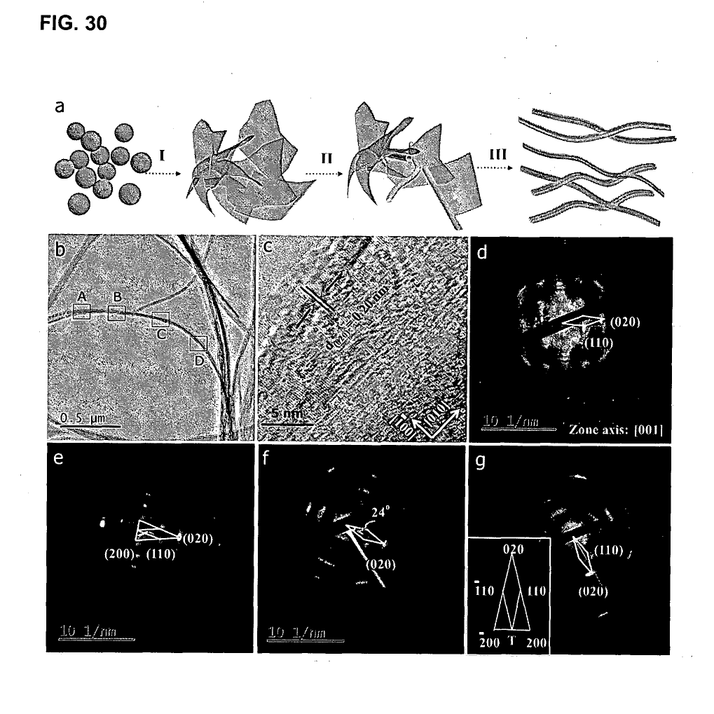

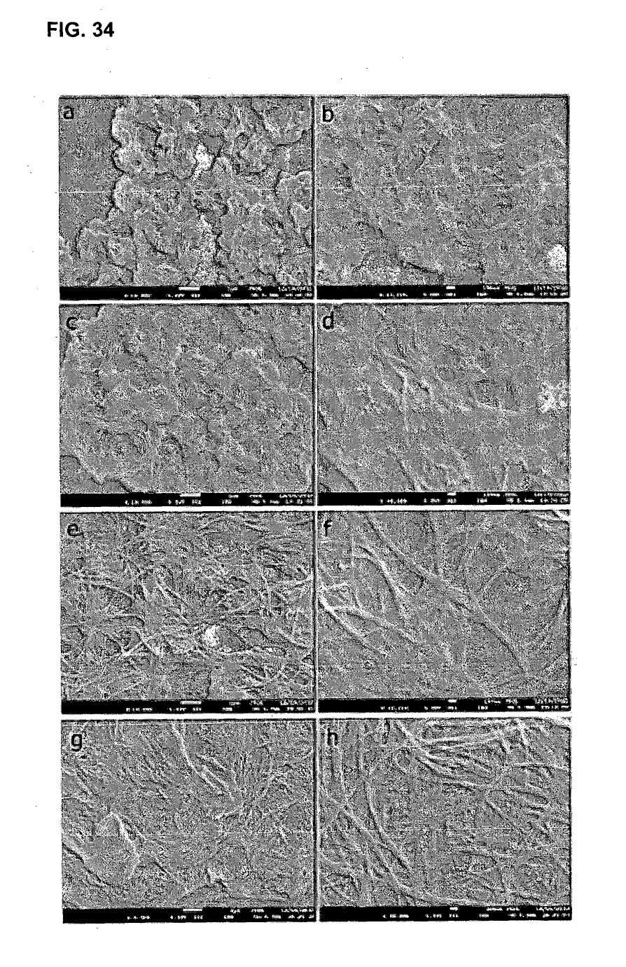

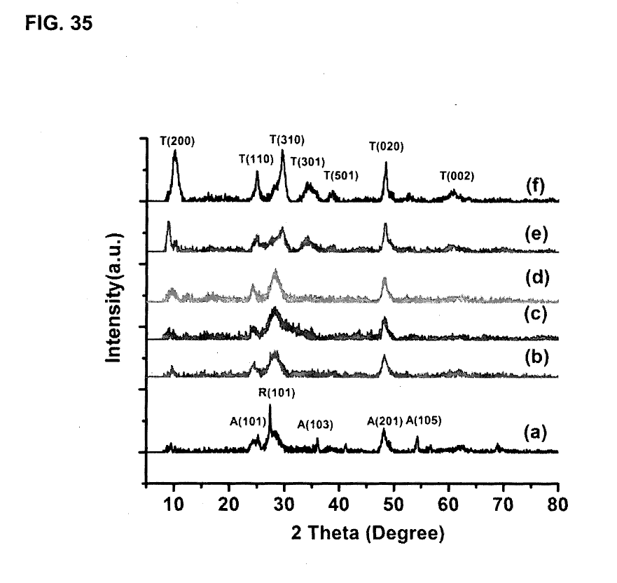

Based on the observation (FIG. 34 and FIG. 35), formation mechanism of elongated nanotube (Scheme in FIG. 30a) was proposed as follows. Firstly, the mechanical stirring accelerated the dissolution-recrystallization rate of the TiO₂ and also shortened the reaction time. This was confirmed by the XRD result for this fast transition from titania to titanate (FIG. 35). In addition, titanate nanosheets was formed as fast as 1 h (FIG. 34a-b, FIG. 30a-I), and it was observed that the nanotubes originated from the titanate nanosheets (FIG. 34c-d, FIG. 30a-II). This phenomenon was consistent with reported formation process of titanate nanotubes via rolling-up nanosheets. Secondly, the fast mass transport in stirred synthesis process increased the diffusion rate of reactants, facilitating the chemical surface reaction on the formed nanotubes (FIG. 30a-III) and thus, elongating the nanotubular structures. The titanate precursor prefered to grow along the axial direction of the nanotube through an oriented crystal growth mechanism, leading to the fast increase of the length of nanotube (FIG. 29j). The increase of the diameter of the nanotube was mainly attributed to merging of parallel orientated multiple nanotubes, evidenced by the TEM images in FIG. 29h and FIG. 32i-j.

In addition, the shear force created by the motion of fluid against titanate nanotube can be used to align nanotubes suspended in the solution. This was because the nanotubes re-orient to the direction of flow of the fluid to minimize the fluid drag force through an oriented attachment mechanism by sharing a common crystallographic orientation. To determine the growth orientation of the elongated nanotube (FIG. 30b) and understand its bending nature, a series of selected area electron diffraction (SAED) patterns were taken. One fringe with interlayer distance of 0.20 nm in the nanotube was observed in FIG. 30c, which corresponded to the (020) planes of orthorhombic titanate crystal structure. The SAED patterns in FIG. 30d-g, taken respectively from the neighboring four domains (domain A, B, C and D) in FIG. 30b displayed the same rhomboid with a small angle of 24° resulting from the (110) and (−110) planes. It was observed that the rotation angle of the (020) plane at different domains was dependent on the bending condition of the nanotube, which further confirmed that the nanotube showed a preferential growth in the [010] crystallographic direction. The spread of diffraction spots from each domain of one nanotube was due to small lattice mismatch from the assembled nanotube bundles. The growth of nanotubes along [010] direction under other stirring conditions can also be observed as disclosed herein (FIG. 32i-j).

The formation mechanism of high aspect ratio titanate nanotube was based on the evolution of morphology and crystal structure of nanotubes, as shown in FIG. 34 and FIG. 35 respectively. Transformation from anatase TiO₂ to titanate started from as early as 1 h, with numerous titanate nanosheets generated from the TiO₂ nanoparticles (P25), bridged together to form the microsphere-like particles (FIG. 34a, b). Such a fast reaction can be attributed to the intense mixing within the autoclave, which increased the contact area of the reactants. The XRD confirmed this fast transition from titania to titanate (FIG. 35), and the sharp peak around 27° belongs to rutile phase of titanium dioxide. No strong peaks from anatase titanium dioxide were observed, indicating that anatase reacts faster during the process.

When the reaction was carried on for 2 h, the XRD result (FIG. 35) indicated the almost dissolution of titania nanoparticles and the recrystallization of titanate nanostructures. Trace amount of long titanate nanotubular structure is observed and the formed titanate nanosheets served as the precursor to grow the elongated titanate nanotube after the disappearance of anatase and rutile peaks of TiO₂. As the reaction time prolonged to 4 h (FIG. 34e-f) and 8 h (FIG. 34g-h), the length of nanotubular structure steadily increased, and the nanotube morphology dominated due to the gradual transition from nanosheets to nanotubes. It can be observed the final products of solution inside the autoclave. The solution showed distinct separation of phases below 8 h, but if the reaction was extended for longer than 16 h, intimate mixture was observed, which was a sign of the formation of entangled nanotubular structure.

After 16 h of reaction, the obtained products were long and entangled nanotubular structure (not shown) with a sharp peak of high intensity, which was comparable to that of 24 h (FIG. 32a).

To sum up, elongated titanate nanotubes integrated with bending nature and large scale uniformity were successfully achieved by a stirring hydrothermal approach. Although the method based on the external rotation of whole hydrothermal reactor was reported, length of the nanotubes was still limited to one-micrometer and the uniformity was not very ideal. In addition, it still suffered from aggregation and was not able to form cross-link network electrode materials. While in present approach, the internal stirring of whole fluid within the reactor played an important role in formation of elongated titanate nanotubes. The stirring process simultaneously improved the diffusion and surface chemical reaction rates of reacted precursor in solution, which enabled fast attachment of titanate nanocrystals on the formed nanotubes and thus lengthened the nanotubes. Meanwhile, the intense stirring homogeneously blended the reacted solution and precursor, producing the uniform elongated nanotubes in large scale. Furthermore, the shear stress forced the bending of nanotube during the stirring process. Benefited from this protocol, the formed elongated nanotubes with bending nature as disclosed herein is suitable for building a robust cross-link network electrode.

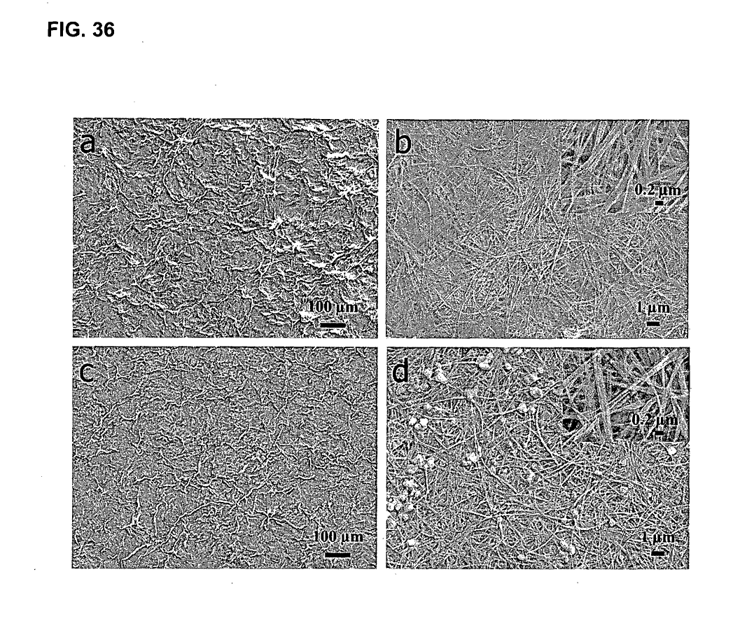

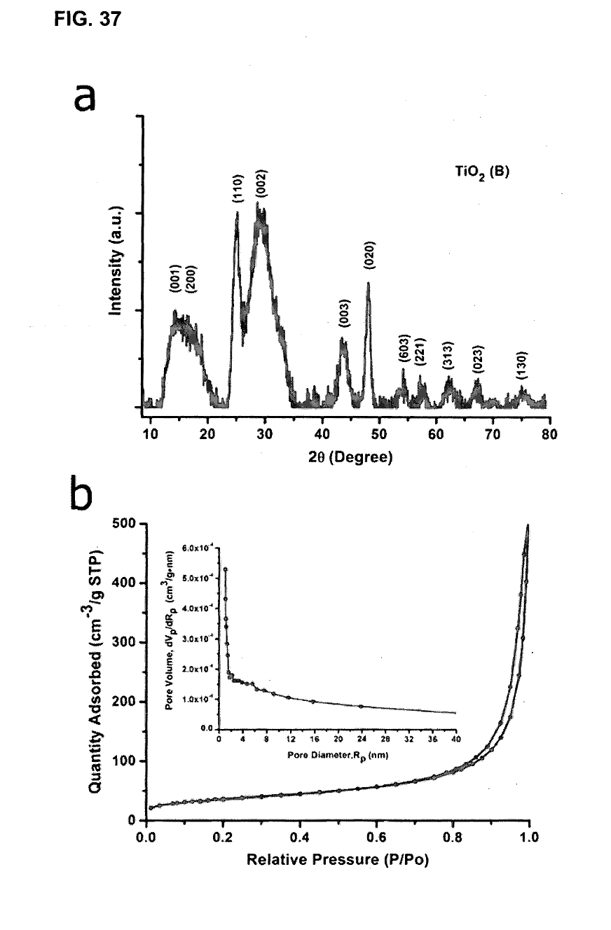

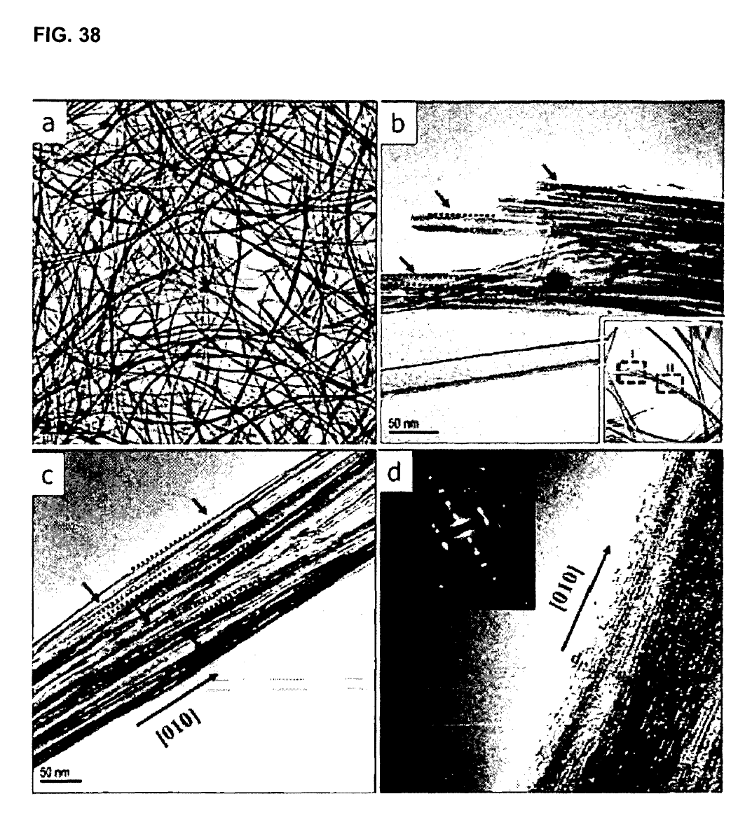

As a proof-of-concept for LIB devices study, elongated TiO₂(B) nanotubular anode electrode from the direct dehydration of long hydrogen titanate nanotubular samples on copper foil without the use of auxiliary additives (e.g., binder and carbon black) by thermal treatment in vacuum was then prepared. The titanate nanotubes assembled to form three-dimensional TiO₂(B) network during heat treatment (FIG. 36a-b), which was probably due to the strong interaction between the nanotubes. The characteristic peaks in XRD pattern (FIG. 37a) confirmed the formation of TiO₂(B) crystal structure after thermal treatment, and surface area of the elongated TiO₂(B) nanotube was about 130.2 m²/g (FIG. 37b) with the mesoporous structure. TEM image in FIG. 38a showed that the TiO₂(B) nanotubular structure preserved the morphology of pristine hydrogen titanate nanotube materials. The multi-wall nanotubular morphology (FIG. 38b-c) along the same [010] direction was also observed (FIG. 38d), resulting in the spread of selected area electron diffraction (SAED) spots from (200), (110) and (020) planes of TiO₂(B) (inset in FIG. 38d). High-resolution TEM images in FIG. 38d revealed the lattice fringes of 0.6 nm, corresponding to the (200) layer distance of TiO₂(B) crystal. These results clearly confirmed that the as-prepared material was an amalgamation of TiO₂(B) polymorph, mesoporous structure and elongated tubular morphology.

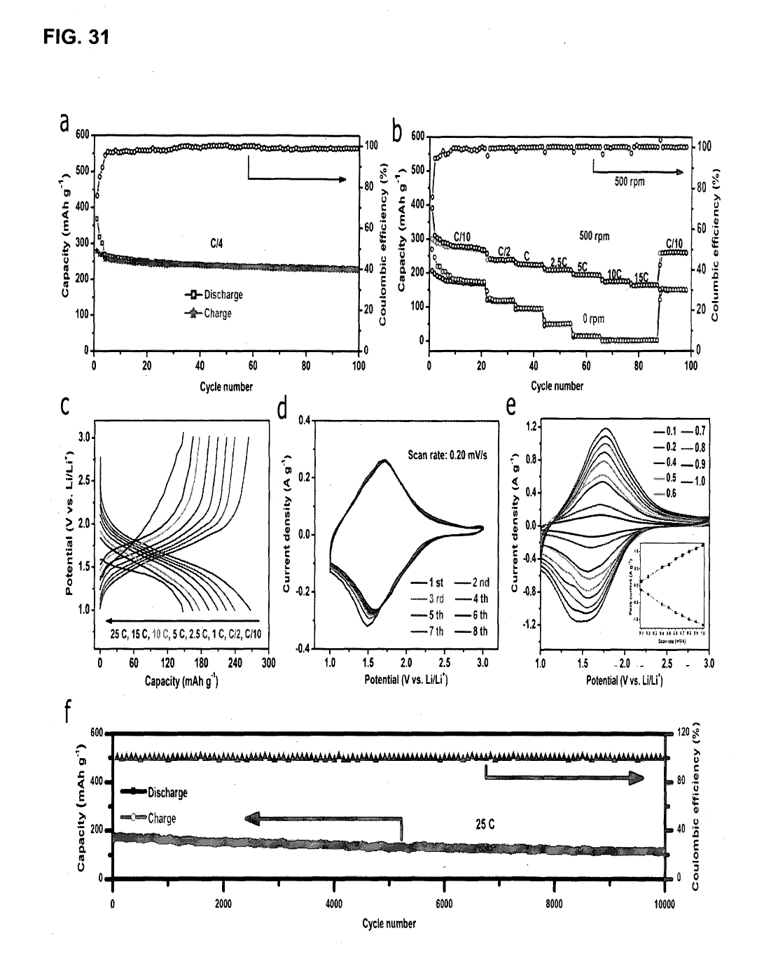

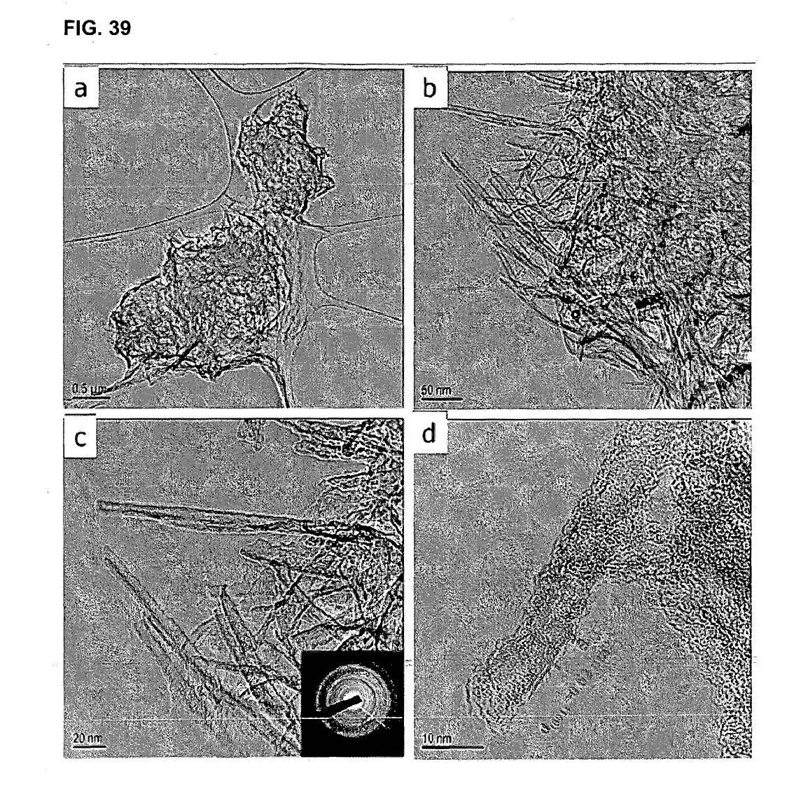

The electrochemical properties of the elongated TiO₂(B) electrode was evaluated in LIBs, and the performance was shown in FIG. 31. The assembled cells exhibited high capacity for the first cycle with the discharge and charge capacities of around 368 and 279 mAh g⁻¹ (FIG. 31a) respectively at a current density of C/4 (1 C=335 mA g⁻¹). Capacity loss at high potential (above 1 V vs. Li/Li⁺) in the first cycle may be attributed to the irreversible interfacial reaction between TiO₂(B) and the electrolyte, which was experientally evidenced and can be mitigated by surface treatments. The discharge and charge capacity difference faded along with the increment of the cycle number as the Coulombic efficiency increased and reached nearly 100% after several cycles, and the discharge capacity remained as high as 227 mAh g⁻¹ after 100 cycles. In FIG. 31b, it can be seen that the discharge capacity varied from 267, 239, 224, 209, 193, 176 to 164 mAh g⁻¹ with the increasing current rate from C/10, C/2, C, 2.5 C, 5 C, 10 C to 15 C. The capacity then increased back to 260 mAh g⁻¹ when the current rate returned to C/10, and it maintained almost 97% of the initial capacity at C/10. Furthermore, ultrahigh Coulombic efficiency value of nearly 100% can be obtained even when gradually increased current rates are applied. Even at ultra-high rate of 25 C (FIG. 31c), the capacity of this lithium-ion cell can reach around 147 mAh g⁻¹. In contrast, the short TiO₂(B) nanotube sample (FIG. 39), obtained from the same thermal treatment process of the short hydrogen titanate nanotube formed at static condition (0 rpm), showed poor performance and maintained only a capacity of 1 mAh g⁻¹ at current rate of 15 C.

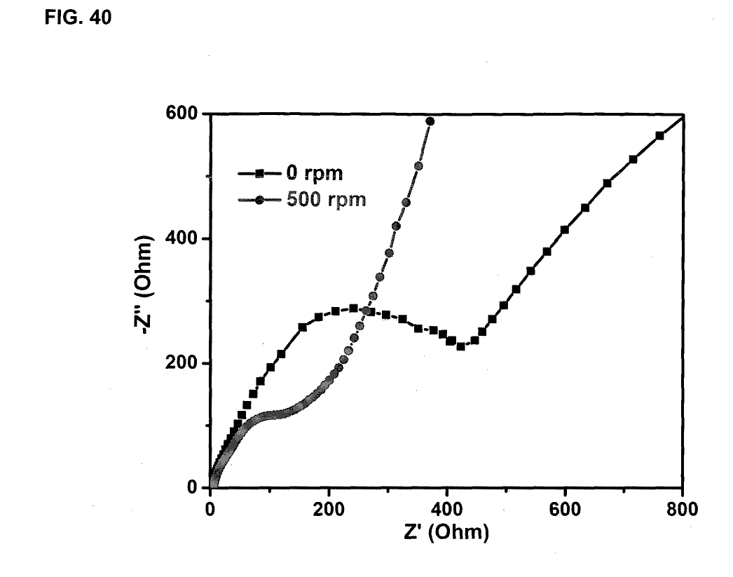

Electrochemical impedance spectroscopy (EIS) measurement in FIG. 40 revealed that the elongated nanotubular electrodes with high rate capability possessed lower ionic and electronic resistance compared to that of short nanotubular electrode, hence the kinetics of lithium insertion/de-insertion rate of the former electrode was faster. Benefited from this merit, the rate capacity of elongated TiO₂(B) electrode drops slightly at higher discharge rates in FIG. 31b-c.

The pseudocapacitive charge storage behavior existed in TiO₂(B) nanotube, as a nearly constant slope of galvanostatic (current-potential) characteristics was observed at different discharging rates (FIG. 31c). The redox reaction in FIG. 31d revealed that the pseudocapacitive storage behavior originated from pure phase of TiO₂(B) nanotubular electrode as its broad pair of characteristic peaks (1.5-1.6 V/1.7 V) appeared in cyclic voltammogram (CV) measurement. This was consistent with the XRD result (FIG. 37a). In addition, there was no significant change of the CV curves after the 4th cycle (FIG. 31d), suggesting stable storage and release of Li ions in TiO₂(B) nanotubular electrode. The CV measurement at different scan rates of 0.1-1.0 mV/s in FIG. 31e clearly showed that the peak current varied linearly with the first power of scan rate, further evidencing the fast pseudocapacitive charge storage process of the TiO₂(B) electrode. Here, it was realized the remarkable high-rate performance LIBs based on elongated TiO₂(B) nanotubular structure, which was due to the successful integration of the following key characteristics in current battery system. Beyond the intrinsic fast pseudocapacitive charge mechanism, the 1D elongated TiO₂(B) nanotubular structure disclosed herein (FIG. 38a), not only provided the direct and rapid ion/electron transport pathways, but also ensured that the nanotubes glue together to form a mechanical stability of crosslinked network (FIG. 36a-b) due to their unique bending nature. In addition, the intrinsic low volume expansion of TiO₂(B) materials upon lithiation and delithiation stabilized nanotubular morphology and electrode architecture at high rates. As a result, the TiO₂(B) nanotubular network morphology was well retained after long-time cycling, which was confirmed by FESEM images in FIG. 36c-d. Meanwhile, with the mesoporous structure (FIG. 37b) and thin tube thickness (FIG. 38c), the electrode can offer adequate interfacial area for the electrochemical reactions and short diffusion length respectively. As a result, the integrated TiO₂(B) nanotubular electrode exhibited superior cycling capacity (ca. 114 mAh g⁻¹) over 10000 cycles at high rate of 25 C (8.4 A/g) synchronized with ca. 100% Coulombic efficiency, proving its excellent tolerance of ultrafast insertion and extraction of lithium ions for long-life LIBs.

In summary, a mechanical force-driven method to prepare elongated bending TiO₂-based nanotubes for high-rate LIBs has been developed. Formation of elongated nanotubular structure was due to improvement in diffusion and chemical reaction rates under mechanical agitation, and the bending nature of nanotube resulted from difference in force imposed on the nanotube. Benefited from unique elongated bending nanotubular structure, a robust three-dimensional TiO₂(B) nanotubular cross-linked network anode electrode was fabricated. The electrode exhibited a capacitor-like rate performance and battery-like high capacity for long-time cycling, which may be attributed to the pseudocapacitive charge storage process, short diffusion length, large surface area, as well as reduced electron conductivity of elongated nanotube electrode. This novel synthetic approach could be extended to the fabrication of a wide variety of functional nanomaterials, and the current proof-of-concept study provides new avenues for the future developments of ultrafast rechargeable LIBs.

1. A method of forming titanate nanotubes each having a length of at least 10 μm, the method comprising:
heating a closed vessel containing a titanate precursor powder dispersed in a base, wherein content in the closed vessel is simultaneously stirred with a magnetic stirrer during the heating.

2. The method of claim 1, wherein the closed vessel is heated at 130° C. or below.

3. The method of claim 2, wherein the closed vessel is heated at between 80° C. and 130° C.

4. The method of any one of claims 1 to 3, wherein the closed vessel is heated for 24 h or less.

5. The method of claim 4, wherein the closed vessel is heated for 16 h to 24 h.

6. The method of any one of claims 1 to 5, wherein the closed vessel is heated in an oil bath or an apparatus adapted to provide a constant heating temperature.

7. The method of claim 6, wherein the closed vessel is heated in a silicon oil bath, an oven, or a furnace.

8. The method of any one of claims 1 to 7, wherein the content in the closed vessel is stirred at 400 rpm or more.

9. The method of claim 8, wherein the content in the closed vessel is stirred at 400 rpm to 1,000 rpm.

10. The method of any one of claims 1 to 9, wherein concentration of the titanate precursor powder in the base is about 1:300 g/ml or more.

11. The method of any one of claims 1 to 10, wherein concentration of the titanate precursor powder in the base is in the range of about 1:150 g/ml to about 1:50 g/ml.

12. The method of any one of claims 1 to 11, further comprising collecting the thus-formed titanate nanotubes via centrifugation or filtration.

13. The method of claim 12, further comprising washing the collected titanate nanotubes with deionized water to reduce pH to 9 or below.

14. The method of claim 13, further comprising drying the washed titanate nanotubes.

15. The method of claim 14, wherein drying the washed titanate nanotubes comprises forming the dried titanate nanotubes as a powder or free-standing membrane.

16. The method of any one of claims 1 to 15, wherein the titanate nanotubes comprise TiO₂.

17. The method of any one of claims 1 to 16, further comprising collecting the titanate nanotubes via centrifugation or filtration to form a titanate nanotubes membrane.

18. The method of claim 17, further comprising arranging the titanate nanotubes membrane on a TiO₂ membrane to form a titanate nanotubes-TiO₂ membrane.

19. The method of claim 18, wherein arranging the titanate nanotubes membrane on a TiO₂ membrane comprises
a) heating the titanate nanotubes membrane at a temperature of at least 300° C. to form a TiO₂ nanotubes membrane, and
b) collecting titanate nanotubes via filtration on the TiO₂ nanotubes membrane to obtain the titanate nanotubes-TiO₂ membrane.

20. The method of claim 18 or 19, wherein arranging the titanate nanotubes membrane on a TiO₂ membrane is repeated one or more times to form a multilayer titantate nanotubes-TiO₂ membrane.

21. The method of claim 20, wherein the multilayer titantate nanotubes-TiO₂ membrane comprises one or more titantate nanotubes membrane and one or more TiO₂ membrane arranged in a random sequence.

22. The method of any one of claims 1 to 21, wherein the titanate nanotubes are hollow titanate nanotubes.

23. The method of claim 14, further comprising dispersing the dried titanate nanotubes in an acid to obtain protonated titanate nanotubes.

24. The method of claim 23, further comprising collecting the protonated titanate nanotubes via centrifugation, washing and drying.

25. The method of claim 24, further comprising dispersing the collected protonated titanate nanotubes in a solution containing a silver salt to obtain silver-titanate nanotubes.

26. A method for forming a silver-titanate membrane, comprising:
dispersing silver-titanate nanotubes obtained in claim 25 in deionized water;
filtering the dispersion; and
drying the filtered dispersion.

27. The method of claim 26, further comprising:
contacting the thus-obtained silver-titanate membrane with hydrogen halide solution or gas to form a silver (I) halide decorated titanate membrane; and
exposing the silver (I) halide decorated titanate membrane to at least one of ultra-violet light, visible light and sunlight irradiation.

28. A method for forming an electrode for use in a battery, comprising:
spreading a paste or slurry containing titanate nanotubes obtained in any one of claims 1 to 24 on a metal foil; and
subjecting the metal foil to a vacuum thermal treatment.

29. The method of claim 28, wherein the metal foil is subjected to vacuum thermal treatment at a temperature in the range of about 200° C. to 500° C. for a time period in the range of about 1 h to 5 h.
